(19) United States
(12) Patent Application Publication
(10) Pub. No.: US 2025/0305696 A1
(43) Pub. Date: Oct. 2, 2025

(54) SYSTEMS AND METHODS FOR EVALUATION OF CHILLER PLANT OPERATION ECONOMY

(71) Applicant: HONEYWELL INTERNATIONAL INC., Charlotte, NC (US)

(72) Inventor: Zdenek Schindler, Praha (CZ)

(21) Appl. No.: 18/619,218

(22) Filed: Mar. 28, 2024

(51) Int. Cl. F24F 11/46; F24F 11/64

(52) U.S. Cl. CPC F24F 11/46; F24F 11/64

(57) ABSTRACT

A method for evaluation of chiller plant operation economy is disclosed. The method comprises receiving a first set of data associated with each chiller over a training interval; generating a ML model for each chiller; deploying the generated ML model to a model of each chiller over a ranking interval; receiving a second set of data associated with each chiller, from the sensors; averaging second set of data for each type of sensor across chillers; determining a power consumption of the ML model of each chiller and comparing it over the ranking interval to determine a best ML model; deploying the ML models to an non-degraded chiller plant model and the best ML model to an ideal chiller plant model; comparing the sum of measured actual power consumptions of chillers with calculated consumptions of a non-degraded chiller plant model and ideal chiller plant model to determine estimated potential of savings.

### TECHNOLOGICAL FIELD

The present invention relates to chiller plants, and more particularly relates to a method and system for evaluation of chiller plant operation economy.

### BACKGROUND

Economy of chiller plant operation is primarily determined by efficiency of chillers present in a chiller plant. Typically, main components that affects how well the chiller plant works is how efficient its chillers are. But over time, chillers can start working less efficiently, which makes the chiller plant more expensive to run. In the chiller plant, there are usually several chillers working together to cool a building, and each one can be controlled separately based on how much cooling is needed. Building managers would like a tool that can tell them how energy-efficient the whole chiller plant is, figure out which chillers are causing the most energy loss, and estimate how much it should cost to run the whole chiller plant efficiently. This is not easy because chillers' efficiency changes depending on how they are used and the conditions they are working in. This is the reason it is helpful to have a tool that can smartly analyze how much energy each chiller is using and how well the whole plant is running. By knowing this, managers can plan when to run the chillers, when to do maintenance, and which chillers need attention, which helps save money and energy.

The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### BRIEF SUMMARY

The following presents a simplified summary in order to provide a basic understanding of some aspects of the present disclosure. This summary is not an extensive overview and is intended to neither identify key or critical elements nor delineate the scope of such elements. Its purpose is to present some concepts of the described features in a simplified form as a prelude to the more detailed description that is presented later.

In one example embodiment, a method is disclosed. The method comprises receiving, via at least one processor, a first set of data associated with each of a plurality of chillers of a chiller plant, from one or more sensors, over a training interval. Further, the method comprises generating, via the at least one processor, at least one machine learning (ML) model for each of the plurality of chillers of the chiller plant based at least on the received first set of data. Further, the method comprises deploying, via the at least one processor, the generated at least one ML model to a model of each chiller of the chiller plant over a ranking interval. Further, the method comprises receiving, via the at least one processor, a second set of data associated with each of the plurality of chillers of the chiller plant, from the one or more sensors, over the ranking interval. Further, the method comprises averaging, via the at least one processor, the second set of data associated with each of the plurality of chillers of the chiller plant. Further, the method comprises determining, via the at least one processor, a power consumption of each of the plurality of chillers of the chiller plant based at least on the averaged second set of data, using the at least one ML model. Thereafter, the method comprises comparing, via the at least one processor, the power consumption of each of the plurality of chillers over the ranking interval to determine a best ML model that corresponds to the chiller with the best ML model found by the ranking.

In some embodiments, the one or more sensors comprises at least one of a temperature sensor, a humidity sensor, a calorimeter, and a power meter.

In some embodiments, the first set of data and the second set of data comprises chilled water temperature, cooling water temperature, and cooling demand.

In some embodiments, the training interval and the ranking interval correspond to at least one of hours, days, months, quarters, or years in which the first set of data and the second set of data are received. In some embodiments, the second set of data is averaged to standardize and allow consistent input data for the at least one ML model for each of the plurality of chillers of the chiller plant.

In some embodiments, the method comprises deploying, via the at least one processor, the best ML model for each of the plurality of chillers of the chiller plant to form an ideal chiller plant ML model. Thereafter, the method comprises comparing, via the at least one processor, power consumption of each of the plurality of chillers of the chiller plant under the same averaged conditions in the second set of data with the ideal chiller plant ML model to determine real time efficiency of each of the plurality of chillers of the chiller plant.

In some embodiments, the best ML model corresponds to a model of the chiller among the plurality of chillers having minimum electricity consumption.

In another example embodiment, a system is disclosed. The system comprises a memory and at least one processor is communicatively coupled to the memory. The at least one processor is configured to receive a first set of data associated with each of a plurality of chillers of a chiller plant, from one or more sensors, over a training interval. Further, the at least one processor is configured to generate a machine learning (ML) model for each of the plurality of chillers of the chiller plant based at least on the received first set of data. Further, the at least one processor is configured to deploy the generated at least one ML model to model of each chiller of the chiller plant model over a ranking interval. Further, the at least one processor is configured to receive a second set of data associated with each of the plurality of chillers of the chiller plant, from the one or more sensors, over the ranking interval. Further, the at least one processor is configured to average the second set of data associated with each of the plurality of chillers of the chiller plant. Further, the at least one processor is configured to determine a power consumption of each of the plurality of chillers of the chiller plant based at least on the averaged second set of data, using the at least one ML model. Thereafter, the at least one processor is configured to compare the power consumption of each model of a chiller of the plurality of chillers over the ranking interval to determine a best ML model.

In another example embodiment, a non-transitory machine-readable information storage medium is disclosed. The non-transitory machine-readable information storage medium comprising one or more instructions which when executed by at least one processor to perform operations comprising receiving a first set of data associated with each of a plurality of chillers of a chiller plant, from one or more sensors, over a training interval; generating a machine learning (ML) model for each of the plurality of chillers of the chiller plant based at least on the received first set of data; deploying the generated at least one ML model to model of each chiller of the plurality of chillers of the chiller plant model over a ranking interval; receiving a second set of data associated with each of the plurality of chillers of the chiller plant, from the one or more sensors, over the ranking interval; averaging the second set of data associated with each of the plurality of chillers of the chiller plant; determining a power consumption of each of the plurality of chillers of the chiller plant based at least on the averaged second set of data, using the at least one ML model; and comparing the power consumption of each of the plurality of chiller models over the ranking interval to determine a best ML model.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRA WINGS

Having thus described certain example embodiments of the present disclosure in general terms, reference will hereinafter be made to the accompanying drawings, which are not necessarily drawn to scale, and wherein:

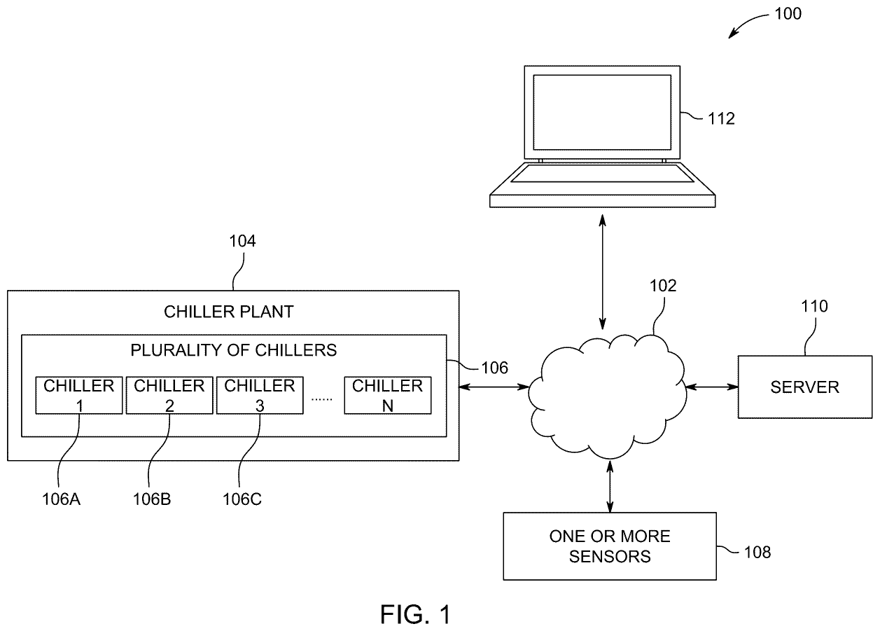

FIG. 1 illustrates a system for evaluation of chiller plant operation economy in accordance with an example embodiment of the present disclosure;

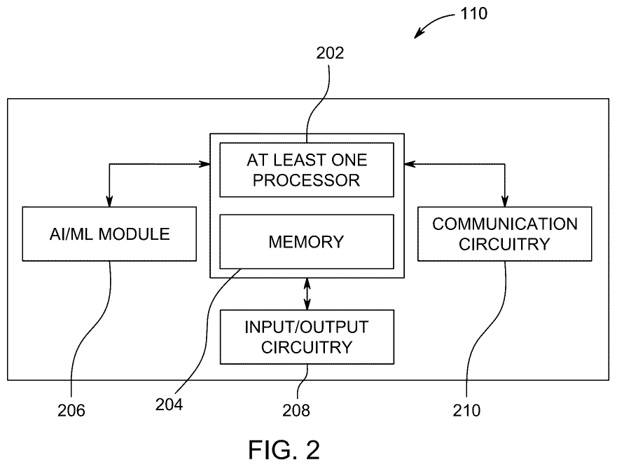

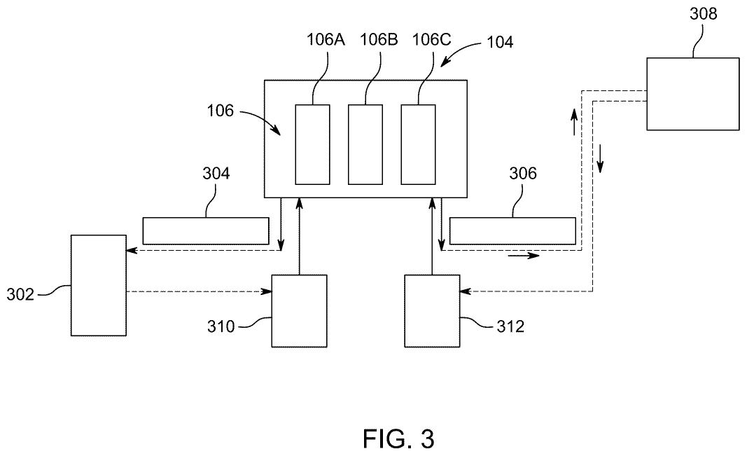

FIG. 2 illustrates a block diagram of a server in accordance with an example embodiment of the present disclosure;

FIG. 3 illustrates an architecture of the chiller plant in accordance with an example embodiment of the present disclosure;

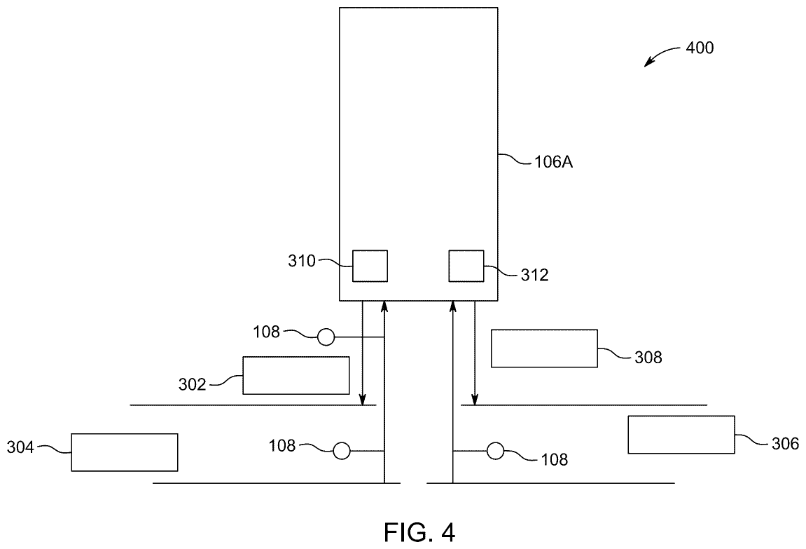

FIG. 4 illustrates an exemplary scenario of the system in accordance with an example embodiment of the present disclosure;

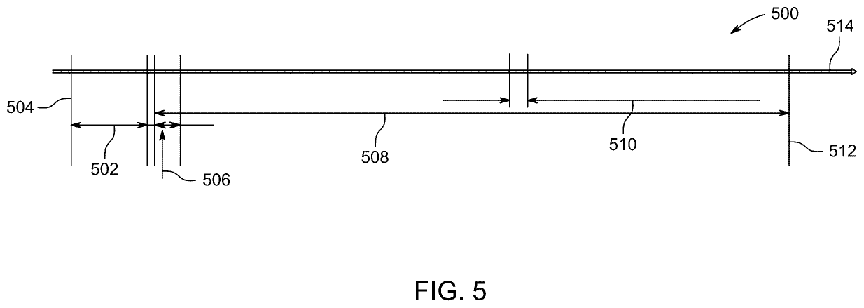

FIG. 5 illustrates a timeline for the operation of the system in accordance with an example embodiment of the present disclosure;

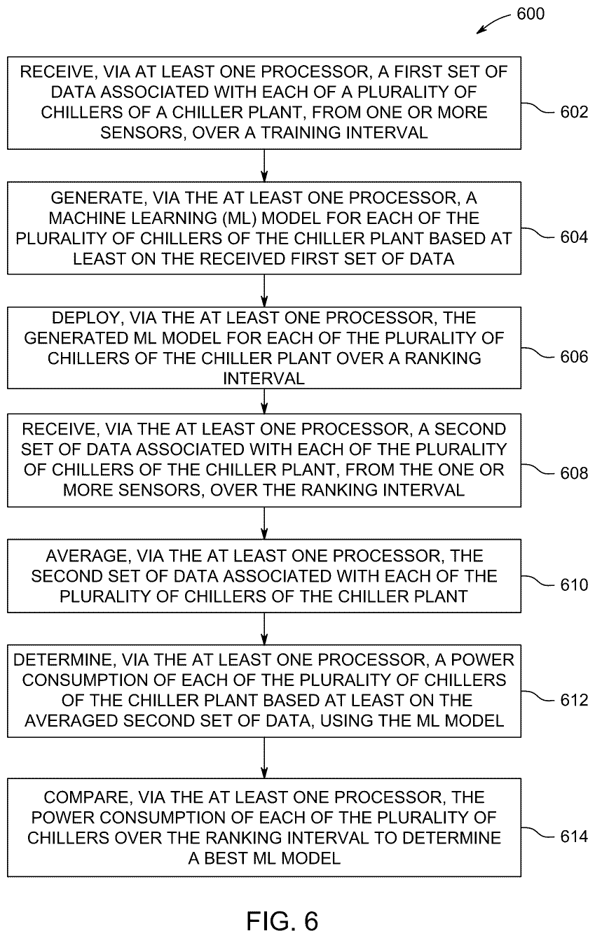

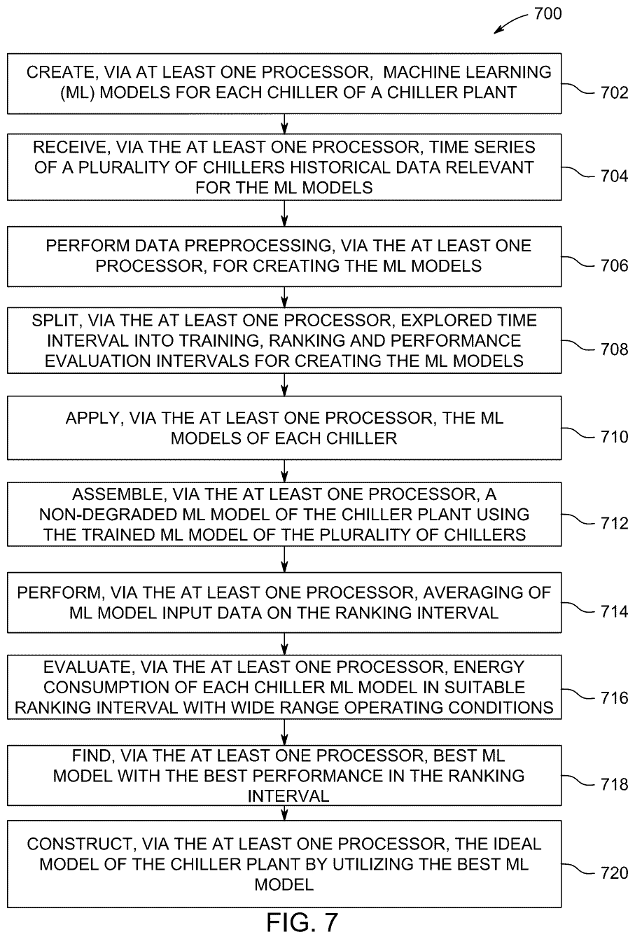

FIG. 6 illustrates a flowchart showing a method of generating a machine learning (ML) model for evaluation of chiller plant economy in accordance with an example embodiment of the present disclosure;

FIG. 7 illustrates a flowchart showing a method for creating chiller plant models in accordance with an example embodiment of the present disclosure;

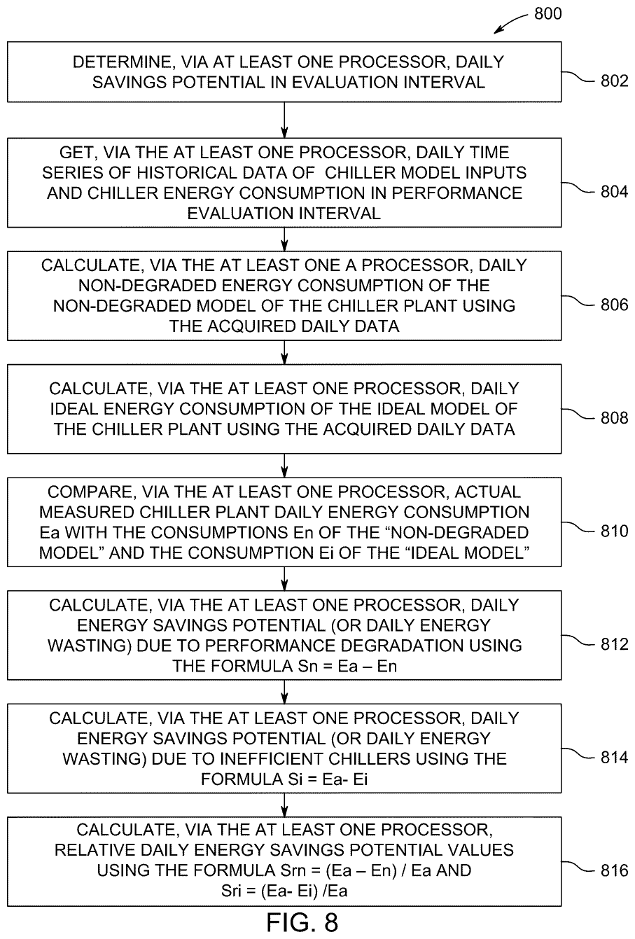

FIG. 8 illustrates a flowchart showing a method for determining daily savings potential in real time in accordance with an example embodiment of the present disclosure;

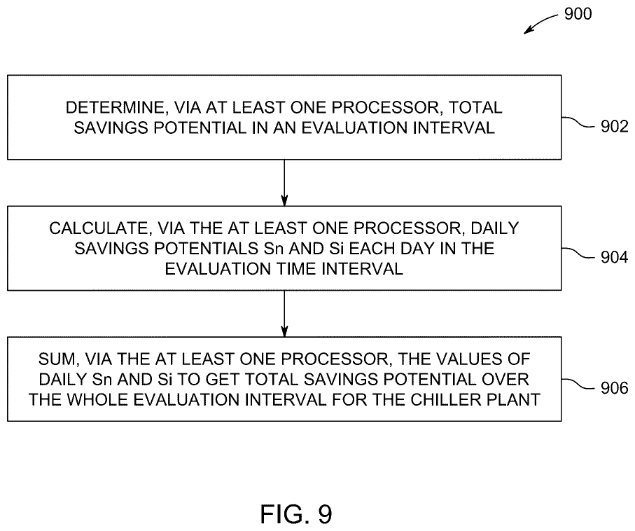

FIG. 9 illustrates a flowchart showing a method for determining total savings potential in in whole performance evaluation interval in real time in accordance with an example embodiment of the present disclosure;

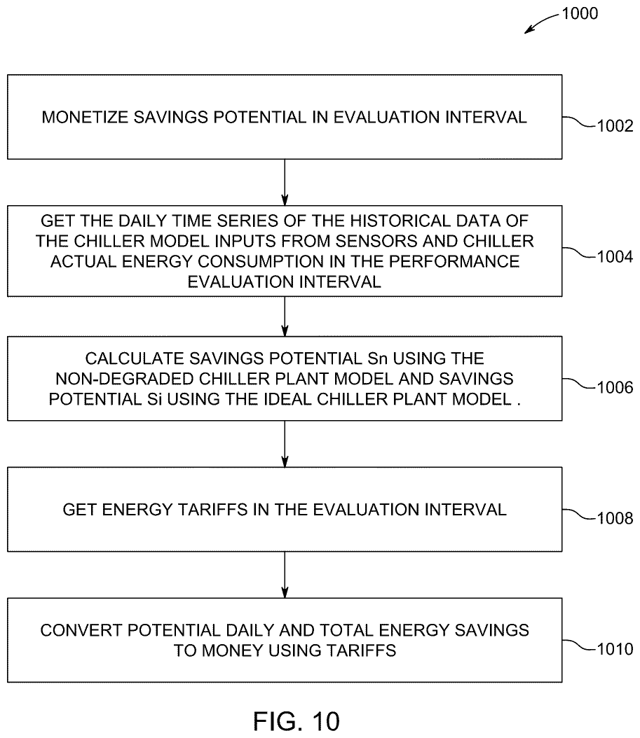

FIG. 10 illustrates a flowchart showing a method for monetizing savings potential in real time in accordance with an example embodiment of the present disclosure;

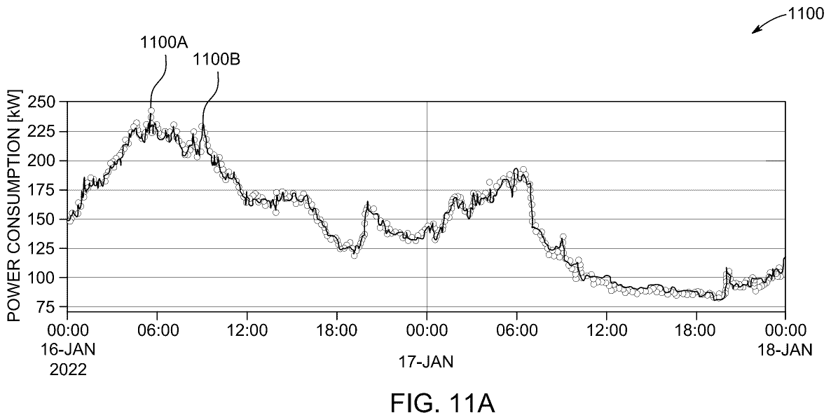

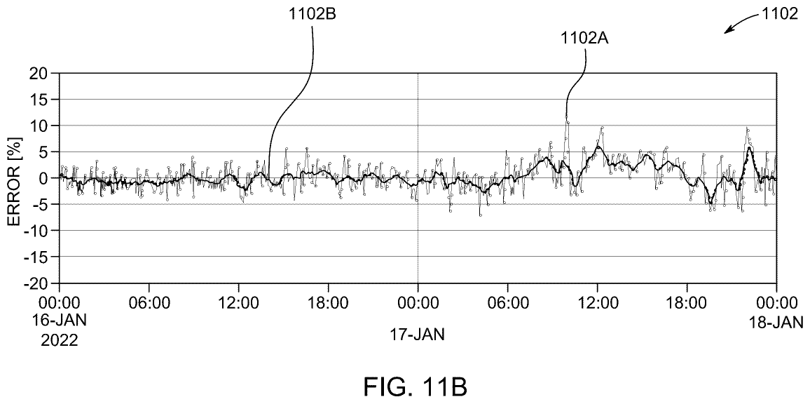

FIGS. 11A-11B illustrate a graphical representation of validation of machine learning (ML) models in accordance with an example embodiment of the present disclosure;

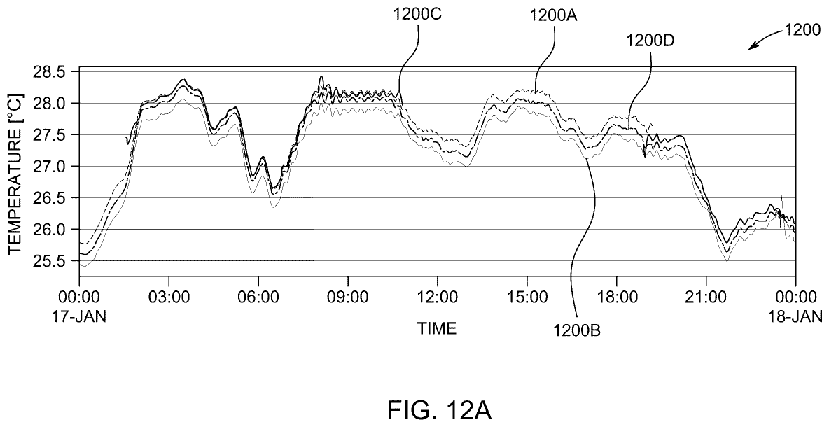

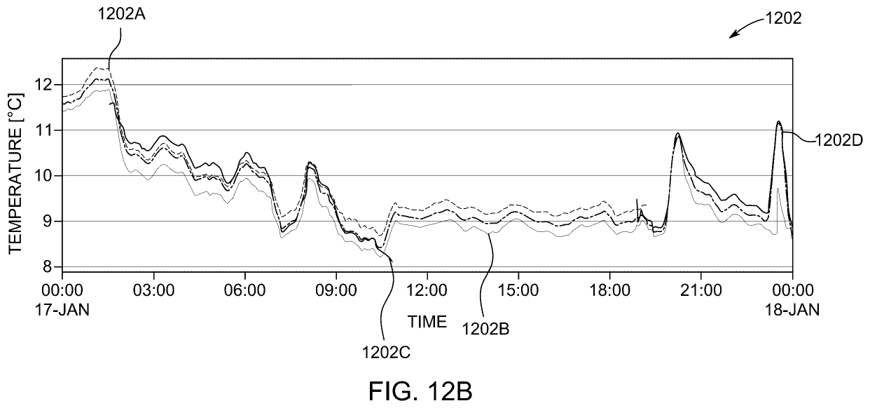

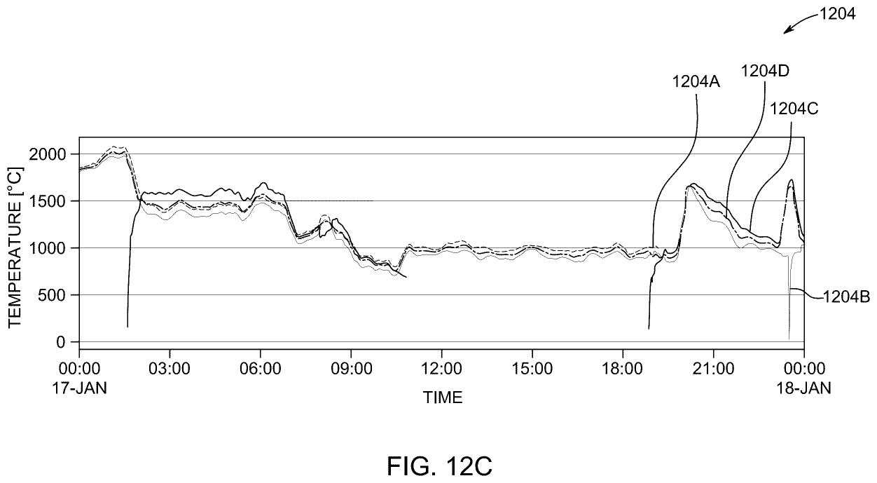

FIGS. 12A-12C illustrate a graphical representation of calculation of mean inputs for the selection of a best ML model in accordance with an example embodiment of the present disclosure;

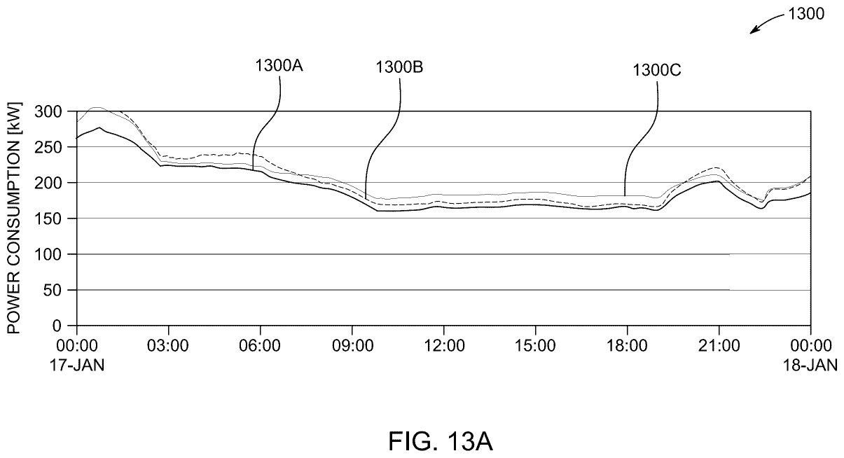

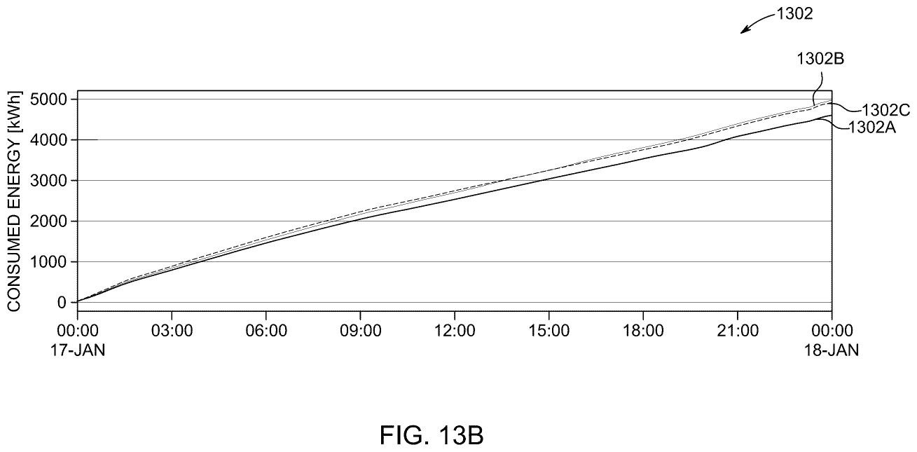

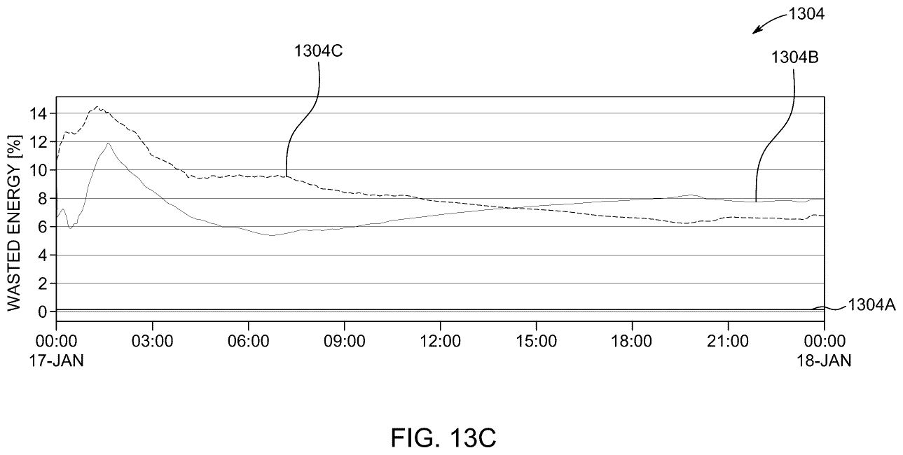

FIGS. 13A-13C illustrate a graphical representation of selection best performing ML model comparing responses of all ML models of chillers on mean inputs in accordance with an example embodiment of the present disclosure;

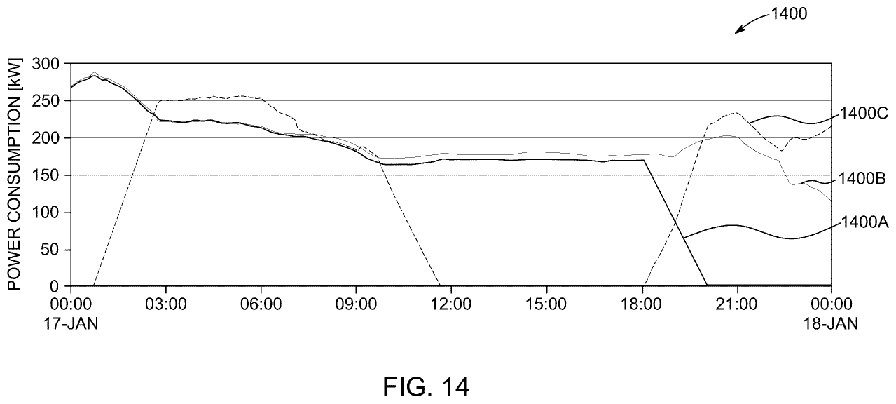

FIG. 14 illustrates a graphical representation of the chiller ML models by response on real inputs in accordance with an example embodiment of the present disclosure;

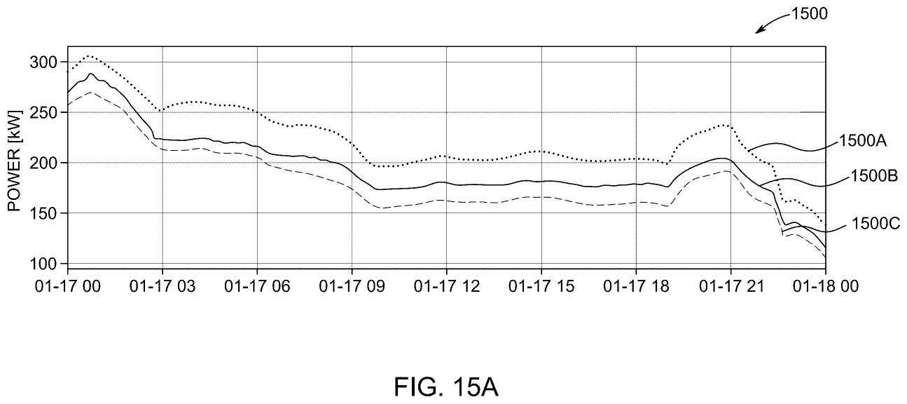

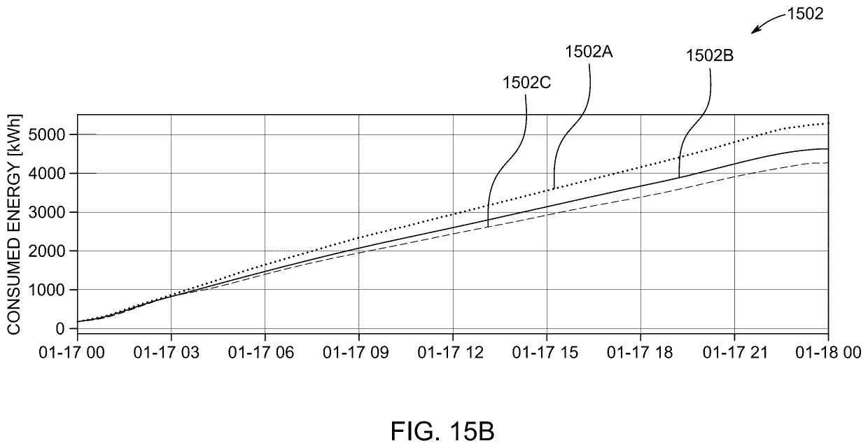

FIGS. 15A-15B illustrate a graphical representation of Comparisons of real chiller consumption to calculated consumptions as responses of models on real measured inputs in accordance with an example embodiment of the present disclosure;

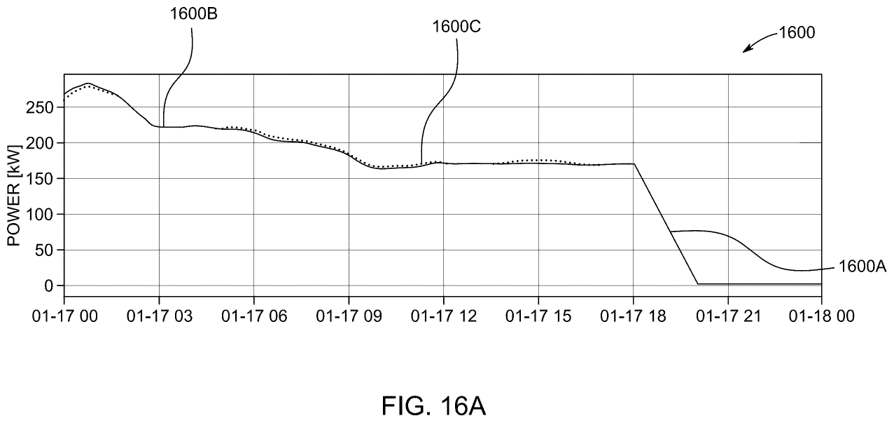

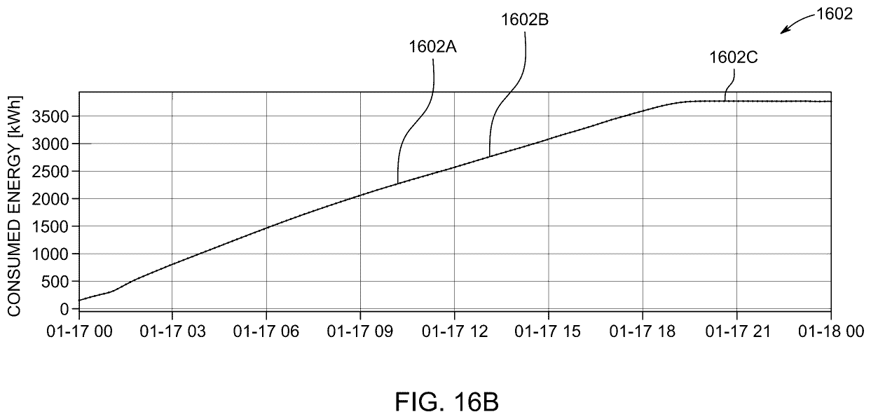

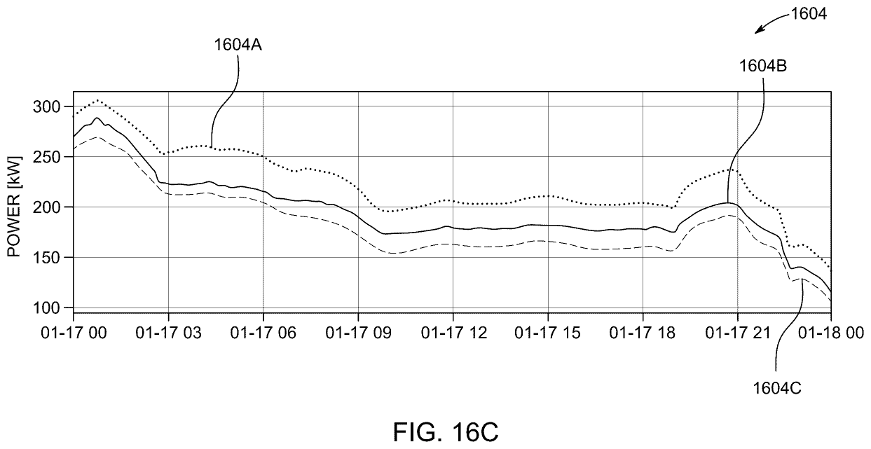

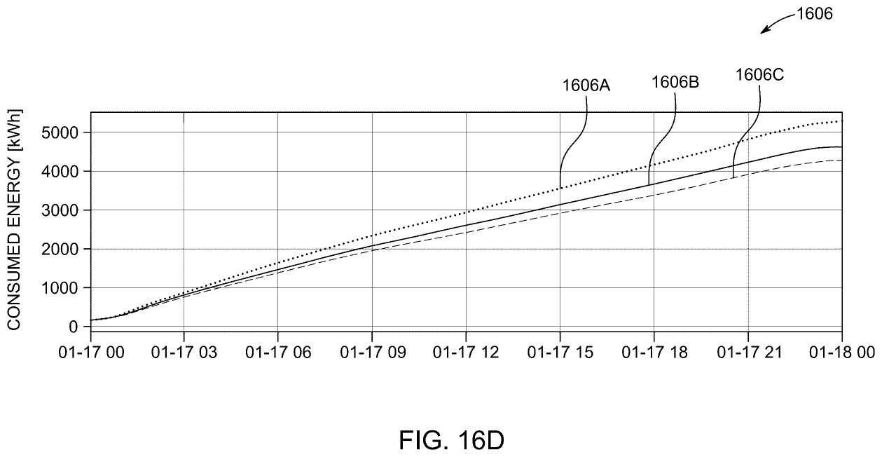

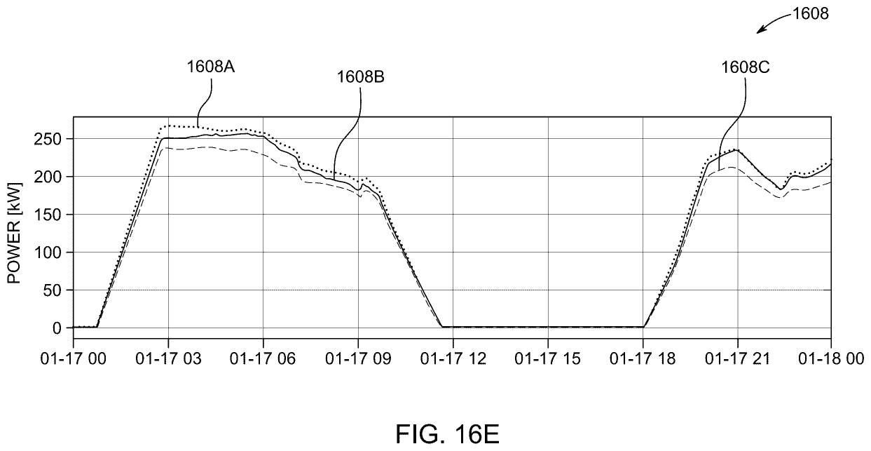

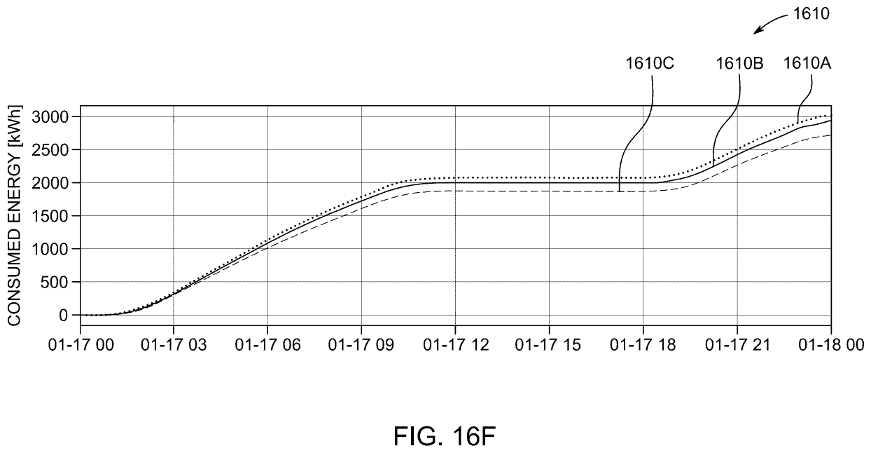

FIGS. 16A-16F illustrate a graphical representation of comparison of real energy consumption of each chillers of the chiller plant to calculate power consumptions as responses of models on real measured inputs in accordance with an example embodiment of the present disclosure;

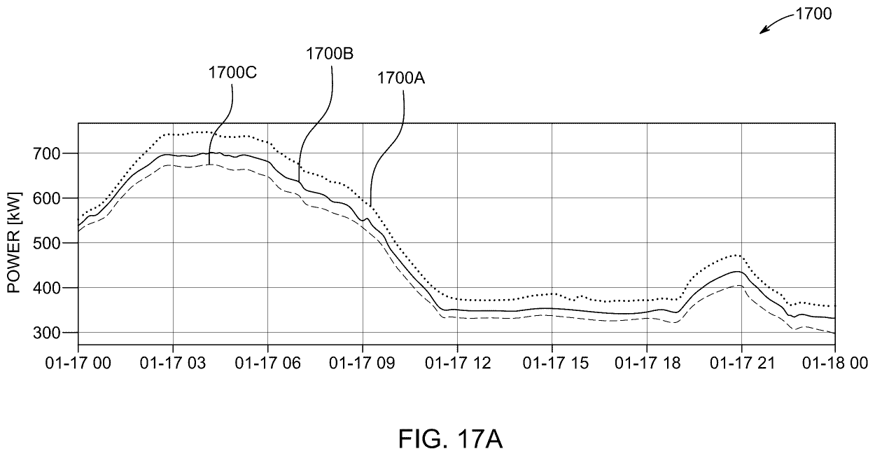

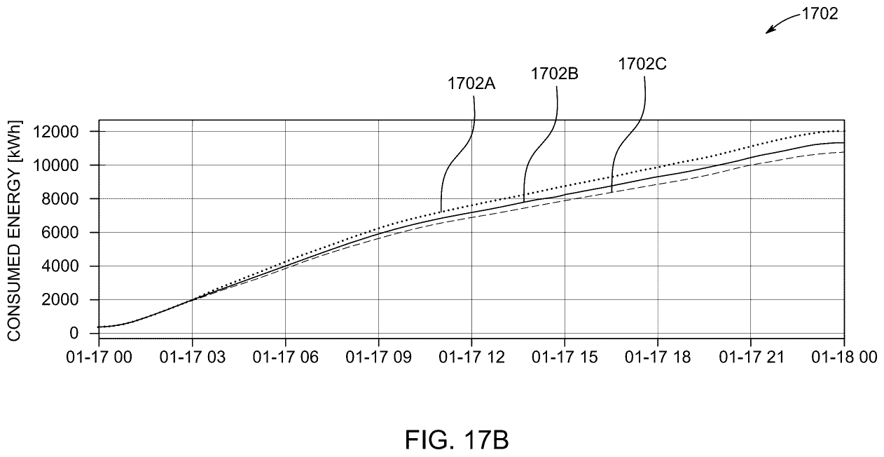

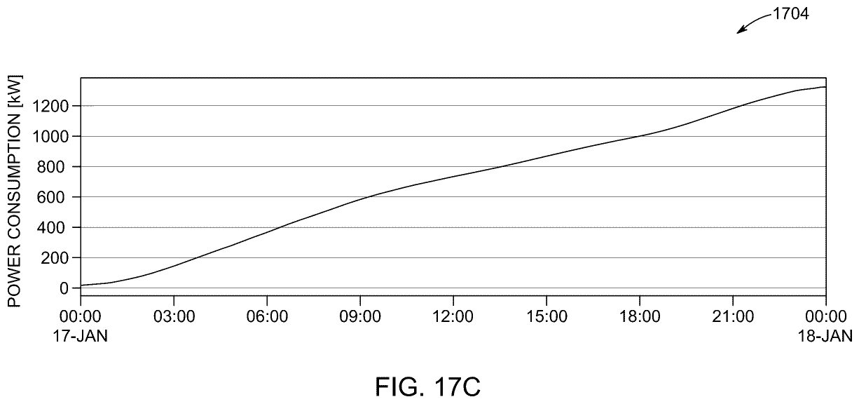

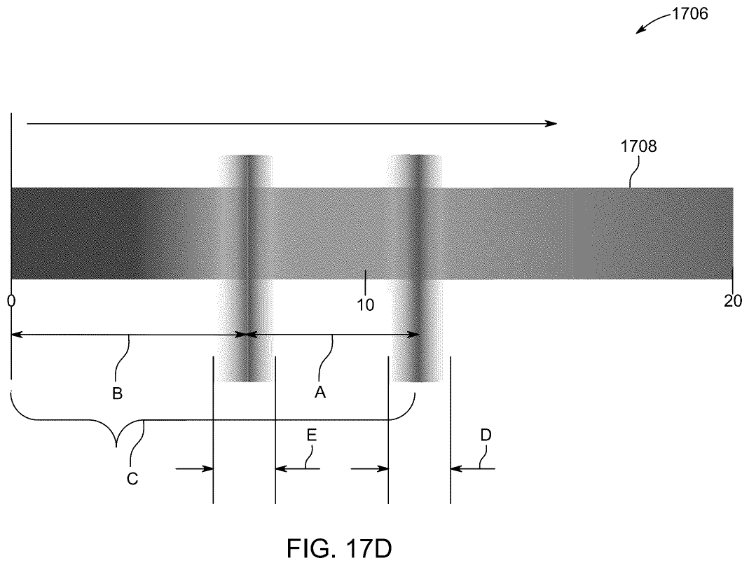

FIGS. 17A-17D illustrate a graphical representation of daily assessment of chiller plant consumptions in accordance with an example embodiment of the present disclosure;

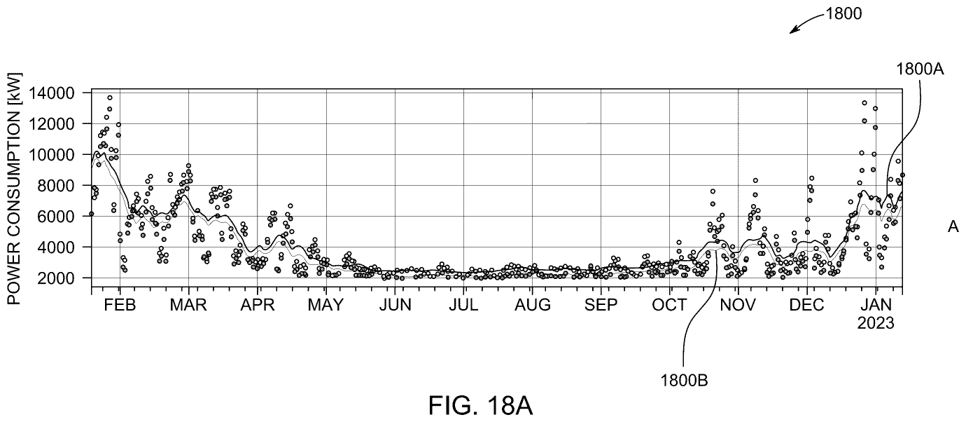

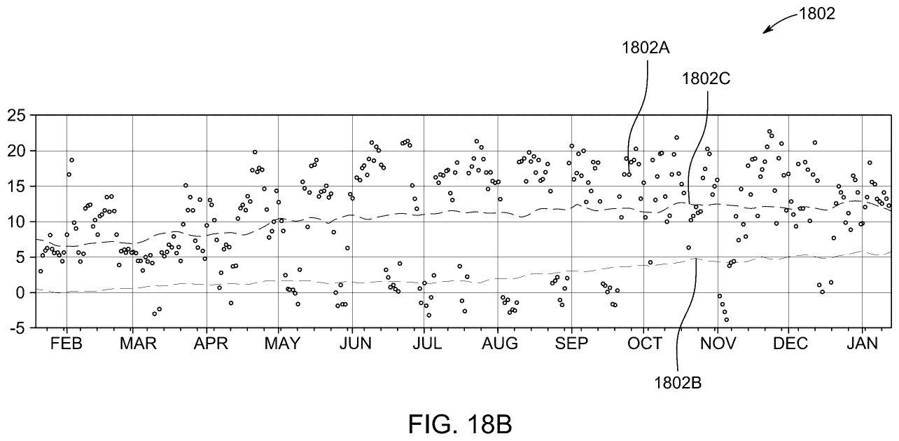

FIGS. 18A-18B illustrate a graphical representation of yearly trend of daily chiller plant consumptions in accordance with an example embodiment of the present disclosure; and

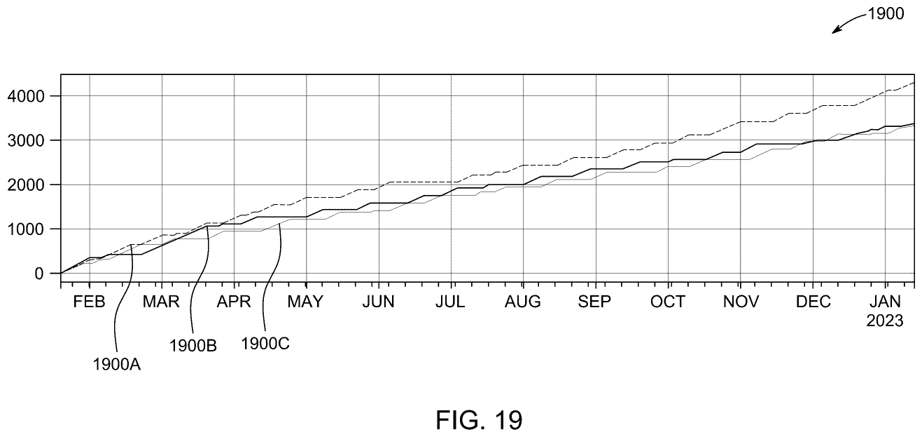

FIG. 19 illustrates a graphical representation of yearly trend of chiller plant operation in accordance with an example embodiment of the present disclosure.

### DETAILED DESCRIPTION

Some embodiments will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements. As discussed herein, the protection devices may be referred to use by humans, but may also be used to raise and lower objects unless otherwise noted.

The components illustrated in the figures represent components that may or may not be present in various embodiments of the invention described herein such that embodiments may include fewer or more components than those shown in the figures while not departing from the scope of the invention. Some components may be omitted from one or more figures or shown in dashed line for visibility of the underlying components.

The present disclosure provides various embodiments of methods and systems for evaluation of chiller plant operation economy. Embodiments may be configured to receive a first set of data associated with each of a plurality of chillers of a chiller plant, from one or more sensors, over a training interval using at least one processor. Embodiments may be configured generate a machine learning (ML) model of chiller energy consumption for each of the plurality of chillers of the chiller plant based at least on the received first set of data. Embodiments may be configured to deploy the generated at least one ML model for each of the plurality of chillers of the chiller plant over a ranking interval. Embodiments may be configured to receive a second set of data associated with each of the plurality of chillers of the chiller plant, from the one or more sensors, over the ranking interval. Embodiments may be configured to average the second set of data associated with each of the plurality of chillers of the chiller plant. In some embodiments, the average is taken for same type of data such as averaging at least one mean chilled water temperature calculated from all chilled water temperatures across the plurality of chillers. Embodiments may be configured to determine a power consumption of each of the plurality of chillers of the chiller plant based at least on the averaged second set of data, using the at least one ML model. Embodiments may be configured to compare the power consumption of each model of a chiller of the plurality of chillers over the training interval to determine a best ML model.

FIG. 1 illustrates a network diagram of a system 100, in accordance with an example embodiment of the present disclosure. The system 100 may comprise a network 102 communicatively coupled with a chiller plant 104 having a plurality of chillers 106, one or more sensors 108, a server 110, and a user device 112.

In some embodiments, the network 102 may be a communication network such as internet or a cloud network, that may be configured to allow computing devices and processing systems to communicate with each other through wired network, wireless network, or a combination of both. In some embodiments, the network 102 may refer to as a distributed infrastructure that is configured to exchange of data, information, and resources among interconnected computing devices and systems. The network 102 may be designed to facilitate communication and collaboration across various locations, devices, and platforms. Those skilled in the art will recognize that wired devices may include, but are not limited to, wired networks such as Wide Area Networks (WANs) or Local Area Networks (LANs), while wireless devices may include wireless communications established via Radio Frequency (RF) signals or infrared signals. Various devices in the system 100 may connect to the network 102 in accordance with various wired and wireless communication protocols such as Transmission Control Protocol and Internet Protocol (TCP/IP), User Datagram Protocol (UDP), and 2G, 3G, or 4G communication protocols.

In some embodiments, the chiller plant 104 may be configured to remove heat from a liquid to remove heat from the indoor air in a building, providing a comfortable temperature for occupants. The chiller plant 104 may further comprise a plurality of chillers 106 including a chiller 106A, a chiller 106B, a chiller 106C, and so on. In some embodiments, the chillers in the chiller plant 104 must be of the same type working in parallel (for example, same nominal capacity, same manufacturer, same type) for the disclosed method to be applicable. The plurality of chillers 106 may contribute to the overall cooling capacity of the building. The plurality of chillers 106 may work together to remove heat from the building's interior, ensuring a comfortable environment for occupants. The plurality of chillers 106 in the chiller plant 104 may be determined by the size of the facility and the cooling requirements.

In some embodiments, the chiller plant 104 may be communicatively coupled to the one or more sensors 108. The one or more sensors 108 may be configured to detect a first set of data associated with each of the plurality of chillers 106 of the chiller plant 104, over a training interval. The one or more sensors 108 may be configured to receive second set of data associated with each of the plurality of chillers 106 of the chiller plant 104, over a ranking interval. In some embodiments, each of the one or more sensors 108 may be placed as close to the respective chiller of the plurality of chillers 106 to minimize error in measurement. Further, each chiller of the plurality of chillers 106 may be coupled with individual one or more sensors 108. However, in some example embodiments, temperature sensor may be used for all the plurality of chillers 106. Further, the one or more sensors 108 may be coupled with the plurality of chillers 106 to detect the first set of data and the second set of data. In some embodiments, the first set of data and the second set of data may correspond to at least one of cooling water temperature circulated by the plurality of chillers 106, chilled water temperature circulated by the plurality of chillers 106, or instantaneous cooling capacity of the plurality of chillers 106. In some embodiments, the training interval and the ranking interval may correspond to at least one of hours, days, months, quarters, or years in which the first set of data and the second set of data are received. Further, the one or more sensors 108 may comprise at least one of a temperature sensor, a humidity sensor, and a power meter.

In some embodiments, the temperature sensor may correspond to at least one of a thermocouple, thermistor, resistance temperature detector (RTD) or infrared (IR) sensor. In an exemplary embodiment, when the temperature sensor corresponds to the thermocouple. Further, the thermocouple may comprise a pair of metallic wires having a junction. Further, the thermocouple may be configured to provide at least one signal when supplied with a pre-defined threshold voltage. In some embodiments, the at least one signal may correspond to an output voltage that may be directly proportional to the temperature gradient of the one or more zones. In some embodiments, the at least one signal corresponds to the at least one of cooling water temperature, chilled water temperature, or instantaneous cooling capacity.

In another exemplary embodiment, when the temperature sensor corresponds to the thermistor. Further, the thermistor may also be referred as a temperature based resistor. The thermistor may be configured to generate the at least one signal when supplied with the pre-defined threshold voltage. In some embodiments, the at least one signal corresponds to the at least one of cooling water temperature, chilled water temperature, or instantaneous cooling capacity.

In another exemplary embodiment, when the temperature sensor corresponds to the RTD or the IR sensor, the RTD or the IR sensor may be configured to provide the at least one signal. In some embodiments, the at least one signal may provide the at least one of cooling water temperature, chilled water temperature, or instantaneous cooling capacity. In some embodiments, the temperature sensor may be configured to generate at least one signal upon supplied with a pre-defined threshold input voltage. In some embodiments, the at least one signal may be configured to provide the at least one of cooling water temperature, chilled water temperature, or instantaneous cooling capacity. In some embodiments, the instantaneous cooling capacity may be measured by the calorimeter. In some embodiments, the calorimeter may include a mass or volume flow rate meter.

In some embodiments, the humidity sensor may be configured to detect air moisture content present within the plurality of chillers 106. Further, the humidity sensor may be configured to operate between a range of 0-100%. Further, the humidity sensor may comprise at least one of a capacitive humidity sensor, a resistive humidity sensor or a thermal humidity sensor. Further, the humidity sensor may be configured to generate at least one signal. In some embodiments, the at least one signal may be configured to provide the humidity data corresponding to a humidity level inside the plurality of chillers 106.

In an exemplary embodiment, when the humidity sensor corresponds to the capacitive humidity sensor. The capacitive humidity sensor may comprise at least two electrodes that may be configured to generate a capacitance when supplied with the pre-defined threshold voltage. Further, the capacitance between the at least two electrodes may be proportional to humidity inside the plurality of chillers 106. In some embodiments, the capacitive humidity sensor may be configured to generate one or more signals corresponds to the humidity data inside the plurality of chillers 106.

In another exemplary embodiment, when the humidity sensor corresponds to the resistive humidity sensor. The resistive humidity sensor may comprise at least two electrodes coated with a layer of moisture sensitive material. Further, the resistive humidity sensor may be configured to provide the one or more signals proportional to the humidity inside the plurality of chillers 106. In another exemplary embodiment, when the humidity sensor corresponds to the thermal humidity sensor. The thermal humidity sensor may be configured to generate the one or more signals corresponding to the humidity level inside the plurality of chillers 106.

In some embodiments, the server 110 may be a computer or software module that is configured to provide centralized resources, data, or services to the user device 112 operated by a user. The server 110 may be configured to handle and manage one or more computational tasks and data processing within the system 100. In some embodiments, the server 110 may include storage systems, such as hard drives or storage arrays, to store and manage large volumes of data and information accessible to network users. In some embodiments, the server 110 may further provide centralized control and management capabilities, allowing network administrators to configure, monitor, and maintain network resources, security settings, and user access permissions from a single location.

In some embodiments, the server 110 may be configured to generate a machine learning (ML) model by receiving the first set of data associated with each of the plurality of chillers 106 of the chiller plant 104, from the one or more sensors 108, via the network 102 over the training interval. Further, the server 110 may be configured to receive the second set of data associated with each of the plurality of chillers 106 of the chiller plant 104, from the one or more sensors 108, via the network 102 over the ranking interval. In some embodiments, a third set of data may be received by the at least one processor 202 from a long term evaluation interval. In some embodiments, the third set of data may be received to evaluate performance and/or efficiency or each chiller of the plurality of chillers 106 and the whole chiller plant 104. In the long term evaluation interval real energy consumption of the chiller plant 104, non-degraded energy consumption of the chiller plant 104 and the energy consumption of the ideal plant are compared to determine economy of the chiller plant 104.

In some embodiments, the server 110 may generate the at least one ML model, using one or more Artificial Intelligence (AI)/Machine Learning (ML) techniques. In one example embodiment, the one or more AI/ML techniques may correspond to natural language processing (NLP), clustering or unsupervised learning, reinforcement learning (RL) or any other AI/ML techniques known in the art.

In some embodiments, the server 110 may further be configured to send data associated with the generated best ML model, ideal chiller plant ML model to the user device 112. The user device 112 may be equipped by a manager of the chiller plant 104 or other service professionals responsible for analyzing the efficiency performance and power consumption of each of the plurality of chillers 106 of the chiller plant 104 over the user device 112. In some embodiments, the user device 112 may include personal computers such as desktop computers, laptop computers, tablets, smartphones, or mobile devices.

FIG. 2 illustrates a block diagram of the server 110 in accordance with an example embodiment of the present disclosure. FIG. 3 illustrates an architecture of the chiller plant 104 in accordance with an example embodiment of the present disclosure. FIG. 4 illustrates an exemplary scenario 400 of the system 100, in accordance with an example embodiment of the present disclosure. FIGS. 2-4 are described in conjunction with FIG. 1.

In some embodiments, the server 110 may comprise at least one processor 202, a memory 204, an artificial intelligence (AI)/machine learning (ML) module 206, an input/output circuitry 208, and a communication circuitry 210. In some embodiments, the at least one processor 202 may be configured to analyze energy consumption associated with each chiller of the plurality of chillers 106 of the chiller plant 104 in real time period using a machine learning (ML) model. In one example embodiment, the real time period may correspond to an evaluation time period of the plurality of chillers 106.

Further, the evaluation time period may comprise a single short time period or occur repeatedly for a sequence of time periods. The at least one processor 202 may be configured to generate the at least one ML model using the AI/ML module 206. In some embodiments, the at least one ML model may correspond to models of energy consumption of the plurality of chillers 106. The AI/ML module 206 may be configured to provide the necessary tools, libraries, or frameworks to facilitate the development and training of the at least one ML model. By utilizing the AI/ML module 206, the at least one processor 202 may effectively process data, apply learning algorithms, and refine parameters to generate the at least one ML model to analyze the energy consumption. Further, the AI/ML module 206 may include XGBoost, Artificial Neural Networks or any other known ML techniques known in the art.

In some embodiments, the at least one processor 202 may be configured to generate the at least one ML model by receiving the first set of data associated with each of the plurality of chillers 106 of the chiller plant 104, from the one or more sensors 108, over the training interval. In some embodiments, the at least one processor 202 may be configured to receive the first set of data associated with each of the plurality of chillers 106 of the chiller plant 104 from the one or more sensors over the training interval. In some embodiments, the at least one processor 202 may be configured to receive the first set of data that comprises chiller water temperature, cooling water temperature, cooling demand of each of the plurality of chillers 106, and/or air moisture content present within the plurality of chillers 106. In some embodiments, the at least one processor 202 may be configured to receive the first set of data from the one or more sensors, where the one or more sensors comprises at least one of the temperature sensor, the humidity sensor, calorimeters, and the power meter.

In some embodiments, the temperature sensor is configured to monitor the temperature of chilled water leaving the chiller. This measurement helps ensure that the chilled water is at the desired temperature set point before it is distributed to various building zones or processes for cooling. In some embodiments, the power meter may be installed to measure the electrical power consumption of each of the plurality of chillers 106 of the chiller plant 104. The power meter is configured to track parameters such as voltage, current, and power factor to calculate the real time power consumption of each of the plurality of chillers 106 of the chiller plant 104.

Further, the at least one processor 202 may be configured to generate the at least one ML model for each of the plurality of chillers 106 of the chiller plant 104 based at least on the received first set of data using one or more Artificial Intelligence (AI)/Machine Learning (ML) techniques. In one example embodiment, the one or more AI/ML techniques may correspond to natural language processing (NLP), clustering or unsupervised learning, reinforcement learning (RL) or any other AI/ML techniques known in the art. For instance, the NLP may enable the system 100 to interpret and analyze textual data from one or more sources such as maintenance logs or sensor readings. Additionally, clustering or unsupervised learning may be employed to categorize the temperature data based on similarity or patterns, to facilitate the identification of recurring issues or anomalies. Furthermore, the RL technique may be utilized to dynamically adjust the ambient temperature thresholds or response strategies based on the temperature data and feedback, to optimize the server 110 performance over time. The one or more AI/ML techniques may enable the server 110 to autonomously learn, adapt, and improve a signal generation process, to provide actionable insights and support proactive maintenance efforts.

Further, the at least one processor 202 may be configured to deploy the generated at least one ML model for each of the plurality of chillers 106 of the chiller plant 104 in the ranking interval. In some embodiments, upon training of the at least one ML model by the at least one processor 202 in the training interval, the at least one processor may be configured to deploy the trained at least one ML model in the ranking interval based on the received first set of data from the one or more sensors. Further, the at least one processor 202 may further be configured to receive the second set of data associated with each of the plurality of chillers 106 of the chiller plant 104, from the one or more sensors, over the ranking interval. For example, the at least one processor 202 may be configured to receive the first set of data during the training interval i.e., 1 Mar. 15 Apr. 2023. Further, upon training of the at least one ML model, the at least one processor 202 is configured to receive the second set of data from the one or more sensor during the ranking interval i.e., 16 Apr. to 23 Apr. 2023.

In some embodiments, the at least one processor 202 may be configured to average out the received second set of data in the ranking interval. In some embodiments, the at least one processor 202 is configured to average the received second set of data to standardize inputs for further comparisons. In some embodiments, the averaging of the second set of data by the at least one processor 202 enables to evaluate chiller efficiencies with consistent input data into the at least one ML model for each of the plurality of chillers 106. In an example embodiment, two chillers CH1 and CH2 are running at 10:35 AM, chiller CH0 is off. Further, chilled water temperature, cooling water temperature and cooling demand of chillers CH1 and CH2 are averaged and passed for further chiller efficiency comparisons.

In another example embodiment, two chillers CH1 and CH2 are running at 01:15 PM, chiller CH1 is off. Further, humidity of air cooling the condenser of chillers CH1 and CH2 are averaged and passed for further chiller efficiency comparisons. In some embodiments, the averaging is done for all time points within the ranking interval. In some embodiments, the at least one processor 202 may be configured to determine power consumption of each of the plurality of chillers 106 of the chiller plant 104 based at least on the averaged second set of data, using the at least one ML model.

In some embodiments, the at least one processor 202 may further be configured to compare the power consumption of each chiller of a model of the plurality of chillers 106 over the ranking interval determined based on the averaged inputs to the best ML model. In some embodiments, the best ML model may be defined as the chiller from the plurality of chillers 106 in the chiller plant 104 having minimum energy consumption in a predefined time period in comparison to the other chillers of the plurality of chillers 106 of the chiller plant 104 in the same predefined time period. In some embodiments, the at least one processor 202 may be configured to compare the power consumption of each model of the chiller of the plurality of chillers using the trained at least one ML model for each of the plurality of chillers 106 of the chiller plant 104.

In some embodiments, the at least one processor 202 may further be configured to assemble the best ML model of the chiller plant 104 to generate an ideal chiller plant ML model. In some embodiments, the ideal chiller plant ML model may be defined as the chiller plant 104 having the plurality of chillers 106 having the power consumption of the identified best ML model. In some embodiments, in the ideal chiller plant ML model, the at least one processor 202 is configured to assume that the plurality of chillers 106 of the chiller plant 104 show best power consumption as of the best ML model. In some embodiments, the at least one processor may also be configured to assemble the generated at least one ML model of the ranking interval to form a non-degraded chiller plant 104.

In some embodiments, a plurality of characteristics of each of the chillers of the chiller plant 104 change over time, the best chiller may lose its good parameters and may perform worse than some other chillers over time. Therefore, in some embodiments, the at least one processor 202 may be configured to determine the power consumption of each of the chillers of the chillers plant and repeat the assessment from time to time to check that the chiller order has not changed and eventually update the best ML model. In some embodiments, the periodic re-evaluation for updating the best ML model may be required to keep the ideal chiller plant model up-to-date, especially in the case of long evaluation intervals.

In some embodiments, the at least one processor 202 may be communicatively coupled to the memory 204. The at least one processor 202 may include suitable logic, circuitry, and/or interfaces that are operable to execute one or more instructions stored in the memory 204 to perform predetermined operations. In one embodiment, the at least one processor 202 may be configured to decode and execute any instructions received from one or more other electronic devices or server(s). The at least one processor 202 may be configured to execute one or more computer-readable program instructions, such as program instructions to carry out any of the functions described in this description. Further, the at least one processor 202 may be implemented using one or more processor technologies known in the art. Examples of the at least one processor 202 include, but are not limited to, one or more general purpose processors and/or one or more special purpose processors.

In some embodiments, the memory 204 may be configured to store a set of instructions and data executed by the at least one processor 202. Further, the memory 204 may include the one or more instructions that are executable by the at least one processor 202 to perform specific operations. The memory 204 may be configured to include the instructions to analyze energy consumption associated with each chiller of the plurality of chillers 106 of the chiller plant 104 in real time period using the at least one ML model. The memory 204 may be configured to include the instructions to compare the energy consumption of each model of the chiller of the plurality of chillers 106 with the predefined threshold value related to energy consumption of each of the plurality of chillers 106.

Further, the memory 204 may be configured to include the instructions to determine a performance of each of the plurality of chillers 106 based at least on the comparison. The memory 204 be configured to include the instructions to generate the at least one ML model. It is apparent to a person with ordinary skill in the art that the one or more instructions stored in the memory 108 enable the hardware of the system 100 to perform the predetermined operations. Some of the commonly known memory implementations include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

In some embodiments, the system 100 may further comprise the input/output circuitry 208. The input/output circuitry 208 may enable a user to communicate or interface with the system 100, via one or more user devices (not shown). The one or more user devices may include N number of user devices. In some embodiments, the input/output circuitry 208 may act as a medium to transmit input from the interface to and from the system 100. In some embodiments, the input/output circuitry 208 may refer to the hardware and software components that facilitate the exchange of information between one or more user devices and the system 100.

In one example, the system 100 may include a graphical user interface (GUI) (not shown) as input circuitry to allow the one or more users to input data. The input/output circuitry 208 may include various input devices such as keyboards, barcode scanners, GUI for the one or more users to provide data and various output devices such as displays, printers for the one or more users to receive data. In another example, the input/output circuitry 208 may include various output circuitry such as a display to display the determined performance of each chiller of the plurality of chillers 106 of the chiller plant 104 in a form of graphs representing evaluation of electricity consumption associated with each chiller of the chiller plant 104, using the at least one processor 202.

In some embodiments, the system 100 may further comprise the communication circuitry 210. The communication circuitry 210 may allow the system 100 to exchange data or information with other systems or apparatuses. Further, the communication circuitry 210 may include network interfaces, protocols, and software modules responsible for sending and receiving data or information. In some embodiments, the communication circuitry 210 may include Ethernet ports, Wi-Fi adapters, or communication protocols like HTTP or MQTT for connecting with other systems. The communication circuitry 210 may further include components such as communication modules (e.g., Wi-Fi, Ethernet, cellular), transceivers, antennas, and protocols (e.g., TCP/IP, MQTT, SNMP) for exchanging data with other systems or network devices. The communication circuitry 210 may allow the system 100 to stay up-to-date and accurately track performance of each chiller of the chiller plant 104 in the system 100.

In some embodiments, the input/output circuitry 208 and the communication circuitry 210 may be configured to integrate the system 100 with other systems for centralized monitoring, analysis, and control by operators and automated processes. It will be apparent to one skilled in the art the above-mentioned components of the system 100 have been provided only for illustration purposes, without departing from the scope of the disclosure.

As illustrated in FIG. 3, the chiller plant 104 may comprise the plurality of common headers (not shown). The plurality of common headers may act as a central distribution point for water chilled by the chiller plant 104. In some embodiments, there may be some other collectors for supplying cooling water from cooling towers. Further, chilled water from the plurality of chillers 106 may flow into the plurality of common headers and further, directed to different parts of a facility 302 that require cooling. Furthermore, the chiller plant 104 may include one a plurality of dedicated pipelines “CHW header 304” and “CW header 306”.

Further, the CHW header 304 may be coupled to the facility 302. The CW header 306 may be coupled to a cooling tower 308. The CHW header 304 may be configured to carry chilled water from the plurality of common headers to the facility 302 that needs cooling. The CW header 306 may be configured to transport cooling water from the plurality of chillers 106 to the cooling tower 308. The cooling tower 308 may dissipate heat from the cooling water to allow the cooling water to be reused by the plurality of chillers 106, thereby forming a closed-loop system. The formed closed-loop system may maintain the efficiency of the chiller plant 104 by continuously removing heat from the facility 302 and dissipating the removed heat into the surrounding environment.

In some embodiments, to complete the cooling cycle, the chiller plant 104 may be equipped with a plurality of pumps to circulate chilled water and cooling water throughout the system 100. The plurality of pumps may comprise the “CHW pump 310” from the facility to help circulate chilled water from the facility 302 back to the chiller plant 104 after absorbing heat, and a “CW pump 312” from the cooling tower 308 to circulate cooling water from the cooling tower 308 back to the plurality of chillers 106 after releasing heat. The plurality of pumps may be configured to maintain the flow of water within the system 100 to ensure efficient cooling performance and optimal operation of the chiller plant 104 as a whole. In some embodiments, the combination of the plurality of chillers 106, the CHW header 304, the CW header 306, the cooling tower 308, the CHW pump 310, and the CW pump 312 may form the chiller plant 104 to provide reliable and efficient cooling for large-scale applications.

As illustrated in FIG. 1, the chiller plant 104 may be communicatively coupled to the one or more sensors 108. The one or more sensors 108 may be configured to detect the first set of data associated with each of the plurality of chillers 106 of the chiller plant 104, over the training interval. The one or more sensors 108 may be configured to detect second set of data associated with each of the plurality of chillers 106 of the chiller plant 104, over the ranking interval. Further, each of the one or more sensors 108 may be placed on the CHW header 304, the CW header 306 to detect the first set of data and the second set of data, as illustrated in FIG. 4. In some embodiments, the first set of data and the second set of data may correspond to at least one of cooling water temperature, chilled water temperature, or instantaneous cooling capacity. In some example embodiment, each boiler may have its own instantaneous cooling capacity sensor. In some embodiments, the cooling water temperature and the chilled water temperature may be measured by the one or more sensors 108 placed over the CHW header 304 and similarly the cooling water temperature and the chilled water temperature may be measured by the one or more sensors 108 placed over the CW header 306. Further, all calculations may use one common temperature of the CHW headers 304 and the CW headers 306. In some embodiments, each chiller of the chiller plant 104 may have its own one or more sensors 108 since the parameters measured by the one or more sensors 108 may differ between the plurality of chillers 106 of the chiller plant 104. In some embodiments, the training interval and the ranking interval may correspond to at least one of hours, days, months, quarters, or years in which the first set of data and the second set of data are received.

FIG. 5 illustrates a timeline 500 for the operation of the system 100 in accordance with an example embodiment of the present disclosure. FIG. 5 is described in conjunction with FIGS. 1-4.

In some embodiments, as illustrated in FIG. 2, the at least one processor 202 may be configured to generate the at least one ML model by receiving the first set of data associated with each of the plurality of chillers 106 of the chiller plant 104, from the one or more sensors 108, over a training interval 502. In some embodiments, the at least one processor 202 may be configured to receive the first set of data associated with each of the plurality of chillers of the chiller plant 104 from the one or more sensors over the training interval. In some embodiments, the at least one processor 202 may be configured to receive the first set of data that comprises chiller water temperature, cooling water temperature, cooling demand of each of the plurality of chillers 106. In some embodiments, one or more suitable ML models may be trained in the training interval 502 starting at the beginning of an evaluation time period 504, in which each chiller model from the one or more suitable chiller ML models are trained separately. In one example embodiment, a prerequisite may be necessary for the one or more suitable ML model that may comprise input data to cover the widest possible range of operating states of the plurality of chillers 106.

Further, the at least one processor 202 may be configured to deploy the generate the at least one ML model for each of the plurality of chillers 106 of the chiller plant 104 in a ranking interval 506. In some embodiments, upon training of the at least one ML model by the at least one processor 202 in the training interval, the at least one processor may be configured to deploy the trained ML at least one ML model in the ranking interval 506 based on the received first set of data from the one or more sensors. Further, the at least one processor 202 may further be configured to receive the second set of data associated with each of the plurality of chillers 106 of the chiller plant 104, from the one or more sensors, over the ranking interval 506. For example, the at least one processor 202 may be configured to receive the first set of data during the training interval i.e., 1 Mar. 15 Apr. 2023. Further, upon training of the at least one ML model, the at least one processor 202 is configured to receive the second set of data from the one or more sensor during the ranking interval i.e., 16 Apr. to 23 Apr. 2023.

In some embodiments, the at least one processor 202 may further be configured to compare the power consumption of each model of the chiller the plurality of chillers 106 over the ranking interval to determine the best ML model at the ranking interval 506. In some embodiments, the best ML model may be defined as the chiller from the plurality of chillers 106 in the chiller plant 104 having minimum energy consumption in a predefined time period in comparison to the other chillers of the plurality of chillers 106 of the chiller plant 104 in the same predefined time period. In some embodiments, the at least one processor 202 may be configured to compare the power consumption of each model of the chiller of the plurality of chillers 106 using the trained at least one ML model for each of the plurality of chillers 106 of the chiller plant 104.

Further, the best performing chiller model may be determined as a model with minimum consumption in the ranking interval 506 with average operating conditions. Further, a ML model of virtual ideal chiller plant where the model for the plurality of chillers 106 are replaced by the best performing chiller, may be created. The created model may serve as an ideal chiller plant efficiency baseline. The best performing chiller may be evaluated using the ML model on a long-term evaluation interval 508 and a daily evaluation interval 510.

It will be apparent to one skilled in the art that the plurality of chillers 106 may be degrading throughout the evaluation time period. Further, operating conditions may be changing. As a result, the efficiency of the plurality of chillers 106 and the consumption of the chiller plant 104 may change that may be found using non-degraded chiller plant ML model. In some embodiments, the system 100 may be configured to compare actual energy consumption of the chiller plant 104 with the consumption of the plant assembled from non-degraded chiller ML models, and the consumption of the ideal chiller plant assembled from best performing chiller ML models within the long-term evaluation interval. For instance, the system 100 may compare the sum of the actual measured power consumptions of the chillers in the chiller plant 104 (i.e., the actual consumption of the whole chiller plant 104) with the calculated consumptions of the non-degraded chiller ML models and the ideal plant model. It will be apparent to one skilled in the art that the characteristics of the plurality of chillers 106 may change over time and the best chiller from the plurality of chillers 106 may lose the good parameters and perform worse than other plurality of chillers 106 in the same chiller plant 104 over time.

As a result, the assessment may be repeated from time to time to check whether the order of the plurality of chillers 106 has not changed and eventually update the best chiller. In some embodiments, a periodic re-evaluation may be needed to keep the ideal chiller plant model up-to-date, especially in the case of long-term evaluation interval 508. In some embodiments, the long-term evaluation interval 508 may be monitored between 504-512. Further, the long-term evaluation interval 508 and the daily evaluation interval 510 may be calculated on a time axis 514.

It will be apparent that the components of the system 100 disclosed herein are provided only for illustrative purposes. Any modification to the current design and overall operation may be well appreciated, without departing from the scope of the disclosure.

FIG. 6 illustrates a flowchart showing a method 600 of generating a machine learning (ML) model for evaluation of the chiller plant 114 operation economy, in accordance with an example embodiment of the present disclosure. FIG. 6 is described in conjunction with FIGS. 1-5.

At operation 602, the at least one processor 202 may be configured to receive the first set of data associated with each of a plurality of chillers 106 of the chiller plant 104, from one or more sensors, over the training interval 502. In some embodiments, the at least one processor 202 may be configured to receive the first set of data associated with each of the plurality of chillers 106 of the chiller plant 104 from the one or more sensors over the training interval. In some embodiments, the at least one processor 202 may be configured to receive the first set of data that comprises chilled water temperature, cooling water temperature, cooling demand of each of the plurality of chillers 106. In some embodiments, the at least one processor 202 may be configured to receive the first set of data from the one or more sensors, where the one or more sensors comprises at least one of the temperature sensors, the humidity sensor, cooling demand, and the power meter.

For example, a chiller plant 104 having a plurality of chillers 106 are installed at a facility 302 for providing a comfortable environment inside the facility 302. Further, each of the plurality of chillers 106 are installed with the one or more sensors 108. The one or more sensors 108 are configured to provide a first set of data, associated with each of the plurality of chillers 106. Further, at least one processor 202 is configured to receive the first set of data during the training interval i.e., 1 Mar.-15 Apr. 2023.

At operation 604, the at least one processor 202 may be configured to generate the machine learning (ML) model for each of the plurality of chillers 106 of the chiller plant 104 based at least on the received first set of data. Further, the at least one processor 202 may be configured to generate the at least one ML model for each of the plurality of chillers 106 of the chiller plant 104 based at least on the received first set of data using one or more Artificial Intelligence (AI)/Machine Learning (ML) techniques. In one example embodiment, the one or more AI/ML techniques may correspond to natural language processing (NLP), clustering or unsupervised learning, reinforcement learning (RL) or any other AI/ML techniques known in the art.

For instance, the NLP may enable the system 100 to interpret and analyze textual data from one or more sources such as maintenance logs or sensor readings. Additionally, clustering or unsupervised learning may be employed to categorize the temperature data based on similarity or patterns, to facilitate the identification of recurring issues or anomalies. Furthermore, the RL technique may be utilized to dynamically adjust the ambient temperature thresholds or response strategies based on the temperature data and feedback, to optimize the server 110 performance over time. The one or more AI/ML techniques may enable the server 110 to autonomously learn, adapt, and improve a signal generation process, to provide actionable insights and support proactive maintenance efforts.

For example, the at least one processor 202 is configured to generate a machine learning (ML) model for each of the plurality of chillers 106 of the chiller plant 104, based on the received first set of data. Further, the at least one processor 202 is configured to generate the best ML model (ML1) associated with the first chiller 106A (CH0), a second ML model (ML2) associated with the second chiller 106B (CH1), and a third ML model (ML3) associated with the third chiller 106C (CH2).

At operation 606, the at least one processor 202 may be configured to deploy the generated at least one ML model for each of the plurality of chillers 106 of the chiller plant 104 over the ranking interval 506. In some embodiments, the at least one processor 202 may be configured to deploy the generated at least one ML model for each of the plurality of chillers 106 of the chiller plant 104 in the ranking interval. In some embodiments, upon training of the at least one ML model by the at least one processor 202 in the training interval, the at least one processor may be configured to deploy the trained at least one ML model in the ranking interval based on the received first set of data from the one or more sensors. For example, the at least one processor 202 is configured deploy the generated ML model(s) ML1, ML2, and ML3 for each of the plurality of chillers 106 (CH0, CH1, and CH2). Further, the at least one processor 202 deploys the generated ML model(s) over a ranking interval i.e., 16 Apr. 2023-23 Apr. 2023.

At operation 608, the at least one processor 202 may be configured to receive the second set of data associated with each of the plurality of chillers 106 of the chiller plant 104, from the one or more sensors, over the ranking interval 506. For example, the at least one processor 202 may be configured to receive the first set of data during the training interval i.e., 1 Mar. to 15 Apr. 2023. Further, upon training of the at least one ML model, the at least one processor 202 is configured to receive the second set of data from the one or more sensor during the ranking interval i.e., 16 Apr. to 23 Apr. 2023. For example, the one or more sensors 108 are configured to provide a second set of data, associated with each of the plurality of chillers 106. Further, at least one processor 202 is configured to receive the second set of data during the ranking interval i.e., 20 Jun. 2023-3 Aug. 2023.

At operation 610, the at least one processor 202 may be configured to average the second set of data associated with each of the plurality of chillers 106 of the chiller plant 104. In some embodiments, the at least one processor 202 may be configured to average out the received second set of data in the ranking interval. In some embodiments, the at least one processor 202 is configured to average the received second set of data to standardize inputs for further comparisons. In some embodiments, the averaging of the second set of data by the at least one processor 202 enables to evaluate chiller efficiencies with consistent input data into the ML model for each of the plurality of chillers 106. In some embodiments, the average is calculated for each type of the sensor individually across the chiller plant 104. For example, the chilled water temperatures values of the same time from all chillers 106 running at that time are averaged.

For example, the at least one processor 202 is configured to average the second set of data associated with each of the plurality of chillers 106 (CH0, CH1, and CH2) of the chiller plant 104. Further, the second set of data corresponds to cooling water temperature, chilled water temperature, or instantaneous cooling capacity.

At operation 612, the at least one processor 202 may be configured to determine the power consumption of each of the plurality of chillers 106 of the chiller plant 104 based at least on the averaged second set of data, using the at least one ML model. For example, the at least one processor 202 is configured to average the second set of data associated with each of the plurality of chillers 106 (CH0, CH1, and CH2) of the chiller plant 104. In some embodiments, the average is taken for same type of data such as averaging at least one mean chilled water temperature calculated from all chilled water temperatures across the plurality of chillers 106. Further, the second set of data corresponds to cooling water temperature, chilled water temperature, or instantaneous cooling capacity.

For example, the at least one processor 202 is configured to determine a power consumption (i.e., 15 kW, 18 kW, and 20 kW) using the ML models of each of the plurality of chillers 106 (CH0, CH1, and CH2) of the chiller plant 104 based on the averaged second set of data. The power consumption is calculated during an equal time interval for each of the plurality of chillers 106.

At operation 614, the at least one processor 202 may be configured to compare the calculated power consumption of each model of the chiller of the plurality of chillers 106 over the ranking interval 506 to determine the best ML model. Some embodiments, the at least one processor 202 may further be configured to compare the power consumption of each model of the chiller of the plurality of chillers 106 over the ranking interval to determine the best ML model. In some embodiments, the best ML model may be defined as the chiller from the plurality of chillers 106 in the chiller plant 104 having minimum energy consumption in a predefined time period in comparison to the other chillers of the plurality of chillers 106 of the chiller plant 104 in the same predefined time period. In some embodiments, the at least one processor 202 may be configured to compare the power consumption of each model of the chiller of the plurality of chillers 106 using the trained at least one ML model for each of the plurality of chillers 106 of the chiller plant 104.

For example, the at least one processor 202 is configured to compare the power consumption (i.e., 15 kW, 18 kW and 20 kW) of each ML model of the chiller of the plurality of chillers 106 (CH0, CH1 and CH2) over the ranking interval to determine a best ML model (i.e., ML1).

In some embodiments, the at least one processor 202 may further be configured to assemble the best ML model of the chiller plant 104 to generate an ideal chiller plant ML model. In some embodiments, the ideal chiller plant ML model may be defined as the chiller plant 104 having the plurality of chillers 106 having the power consumption of the identified best ML model. In some embodiments, in the ideal chiller plant ML model, the at least one processor 202 is configured to assume that the plurality of chillers 106 of the chiller plant 104 show best power consumption as of the best ML model. In some embodiments, the at least one processor may also be configured to assemble the generated at least one ML model at the ranking interval to form a non-degraded chiller plant model.

In some embodiments, a plurality of characteristics of each of the chillers of the chiller plant 104 change over time, the best chiller may lose its good parameters and may perform worse than some other chillers over time. Therefore, in some embodiments, the at least one processor 202 may be configured to determine the power consumption of each of the chillers of the chillers plant and repeat the assessment from time to time to check that the chiller order has not changed and eventually update the best ML model. In some embodiments, the periodic re-evaluation for updating the best ML model may be required to keep the ideal chiller plant model up-to-date, especially in the case of long evaluation intervals.

FIG. 7 illustrates a flowchart showing a method 700 for creating the chiller plant models, in accordance with an example embodiment of the present disclosure.

At operation 702, the at least one processor 202 may be configured to create the at least one ML model for each chiller of the chiller plant 104. At operation 704, the at least one processor 202 may be configured to receive time series of the plurality of chillers 106 historical data relevant for the ML models. Further, at operation 706, the at least one processor 202 may be configured to perform data preprocessing via the at least one processor 202 for creating the ML models. Further, at operation 708, the at least one processor 202 may be configured to split explored time interval into training, ranking and performance evaluation intervals for creating the at least one ML model.

At operation 710, the at least one processor 202 may be configured to apply ML to create ML models of each chiller. At operation 712, the at least one processor 202 may be configured to assemble the non-degraded chiller plant ML model of the chiller plant 104 using the trained ML models of the plurality of chillers 106. At operation 714, the at least one processor 202 may be configured to perform averaging of at least one ML model input data on the ranking interval.

At operation 716, the at least one processor 202 may be configured to evaluate energy consumption of each chiller ML model in suitable ranking interval with wide range operating conditions. At operation 718, the at least one processor 202 may be configured to find best ML model having best performance in ranking interval. At operation 720, the at least one processor 202 may be configured to construct the ideal model of the chiller plant 104 by utilizing the best ML model. In some embodiments, the best ML model is determined to construct the ideal model of the chiller plant. For example, one model might only consider temperatures and cooling capacities

FIG. 8 illustrates a flowchart showing a method 800 for determining daily savings potential in real time, in accordance with an example embodiment of the present disclosure.

At operation 802, the at least one processor 202 may be configured to determine daily savings potential in evaluation interval. At operation 804, the at least one processor 202 may be configured to get the daily time series of the historical data of the chiller model inputs and chiller energy consumption in the performance evaluation interval. Further, at operation 806, the at least one processor 202 may be configured to calculate daily non-degraded energy consumption of the non-degraded chiller plant ML model of the chiller plant 104 using the acquired daily data. Further, at operation 808, the at least one processor 202 may be configured to calculate daily ideal energy consumption of the ideal model of the chiller plant 104 using the acquired daily data.

At operation 810, the at least one processor 202 may be configured to compare actual measured chiller plant 104 daily energy consumption Ea with the consumptions En of the “Non-degraded chiller plant ML model” and the consumption Ei of the “Ideal model” within the long-term evaluation time period by using the third set of data. Further, at operation 812, the at least one processor 202 may be configured to calculate daily energy savings potential (or daily energy wasting) due to performance degradation using the formula Sn=Ea−En. Further, at operation 814, the at least one processor 202 may be configured to calculate daily energy savings potential (or daily energy wasting) due to inefficient chillers using the formula Si=Ea−Ei. Thereafter, at operation 816, the at least one processor 202 may be configured to calculate relative daily energy savings potential values using the formula Srn=(Ea−En)/Ea and Sri=(Ea−Ei)/Ea.

FIG. 9 illustrates a flowchart showing a method 900 for determining total savings potential in whole performance evaluation interval 508 in real time, in accordance with an example embodiment of the present disclosure.

At operation 902, the at least one processor 202 may be configured to determine total savings potential in an evaluation interval. At operation 904, the at least one processor 202 may be configured to calculate daily savings potentials Sn and Si each day in the evaluation time interval. Further, the at least one processor 202 may also be configured to calculate relative savings potentials Srn and Sri each day in the evaluation time interval. Further, at operation 906, the at least one processor 202 may be configured to sum the values of daily Sn and Si to get total savings potential over the whole evaluation interval for the chiller plant 104.

FIG. 10 illustrates a flowchart showing a method 1000 for monetizing savings potential in real time, in accordance with an example embodiment of the present disclosure.

At operation 1002, the at least one processor 202 may be configured to monetize savings potential in evaluation interval. At operation 1004, the at least one processor 202 may be configured to get the daily time series of the historical data of the chiller model inputs and chiller energy consumption in the performance evaluation interval. Further, at operation 1006, the at least one processor 202 may be configured to calculate savings potential (Sn) using the non-degraded chiller plant ML model and saving potential (Si) using the ideal chiller plant model. Further, at operation 1008, the at least one processor 202 may be configured to get energy tariffs electric chillers and power tariffs. In some embodiments, the power tariffs may correspond to electricity relevant for evaluated chiller plant. Thereafter, at operation 1010, the at least one processor 202 may be configured to convert energy to money using the energy tariffs.

FIGS. 11A-11B illustrate a graphical representation of validation of machine learning (ML) models, in accordance with an example embodiment of the present disclosure.

As illustrated in FIG. 11A, the graphical representation 1100 comprises a first trend 1100A and a second trend 1100B. Further, the first trend 1100A and the second trend 1100B may be configured to illustrate the accuracy of energy consumption ML model of the chiller 106A of the plurality of chillers 106, over a period of time. Further, the comparison of energy consumptions of the chiller 106A and its ML model may be determined by the first set of data received from a validation interval by the one or more sensors 108. In some embodiments, the validation interval is close to the training interval but does not overlap with the training interval. For example, the ranking interval may be used as the validation interval. Further, the first trend 1100A may represent a predicted power consumption, generated by the ML model, the second trend 1100B may represent real measured power consumption. In some embodiments, the graphical representation 1100 of the first trend 1100A and the second trend 1100B may be configured to provide insights into accuracy and reliability of the ML model. The closer both trends 1100A and 1100B are, the more accurate the model is.

As illustrated in FIG. 11B, the graphical representation 1102 may be configured to provide insights into a model error percentage calculated by the at least one processor 202. Further, the error percentage may correspond to deviation of the energy consumption of the chiller 106A predicted by the ML model from the actual energy consumption. In some embodiments, the graphical representation 1102 may provide insight into accuracy and precision of the ML model. The graphical representation 1102 may comprise a first trend 1102A and a second trend 1102B. Further, the 1102A provides insights into the prediction error calculated as the difference of the actual measured consumption of one of the plurality of chillers 106 and consumption calculated by its ML model. The 1102B provides a curve created by smoothing the points 1102A. In some embodiments, smoothening is done by the at least one processor 202 to remove noise to facilitate the trend evaluation.

FIGS. 12A-12C illustrate a graphical representation of calculation of mean inputs for the selection of the best ML model, in accordance with an example embodiment of the present disclosure.

As illustrated in FIG. 12A, the graphical representation 1200 may be configured to depict temperature of water from the cooling tower 308. Further, the graphical representation 1200 may comprise a first trend 1200A related to temperature of cooling water from towers to the chiller 106A (e.g., CH0) of the plurality of chillers 106. Further, the second trend 1200B may relate to temperature of cooling water from towers to the chiller 106B (e.g., CH1) of the plurality of chillers 106. Further, the third trend 1200C may relate to temperature of cooling water from towers to the chiller 106C (e.g., CH3) of the plurality of chillers 106. Furthermore, the fourth trend 1200D may relate to an average temperature of cooling water from the plurality of chillers 106. In some embodiments, the graphical representation 1200 may comprise observations recorded for at least 24 hours of the temperature of cooling water from the cooling towers 308.

As illustrated in FIG. 12B, the graphical representation 1202 may be configured to depict temperature of chilled water supplied from the facility 302 to the chiller plant 104. Further, the graphical representation 1202 may comprise a first trend 1202A related to temperature of chilled water returning to the chiller 106A (e.g., CH0) of the plurality of chillers 106 from the facility 302. Further, the second trend 1202B may relate to temperature of chilled water returning to the chiller 106B (e.g., CH1) of the plurality of chillers 106 from the facility 302. Further, the third trend 1202C may relate to temperature of chilled water returning to the chiller 106C (e.g., CH3) of the plurality of chillers 106 from the facility 302. Furthermore, the fourth trend 1202D may relate to an average temperature of chilled water returning to the plurality of chillers 106. In some embodiments, the graphical representation 1202 may comprise observations recorded for at least 24 hours of the temperature of chilled water supplied from the facility 302 to the plurality of chillers 106.

As illustrated in FIG. 12C, the graphical representation 1204 may be configured to depict cooling demand from each of the plurality of chillers 106. Further, the graphical representation 904 may comprise a first trend 1204A related to cooling demand from the chiller 106A (e.g., CH0) of the plurality of chillers 106. Further, the second trend 1204B may relate to cooling demand from the chiller 106B (e.g., CH1) of the plurality of chillers 106. Further, the third trend 1204C may relate to cooling demand from the chiller 106C (e.g., CH3) of the plurality of chillers 106. Furthermore, the fourth trend 1204D may relate to an average temperature demand from the plurality of chillers 106. In some embodiments, the graphical representation 1204 may comprise observations recorded for at least 24 hours of the cooling demand from the plurality of chillers 106 to the facility 302.

FIGS. 13A-13C illustrate a graphical representation of selection of the best performing ML model comparing responses of all ML models of chillers on mean inputs, in accordance with an example embodiment of the present disclosure.

As illustrated in FIG. 13A, the graphical representation 1300 may depict power consumption of each of the plurality of chillers 106 calculated by ML models based on the calculated averaged inputs. Further, the graphical representation 1300 may comprise a first trend 1300A, a second trend 1300B and a third trend 1300C. In some embodiments, the first trend 1300A, the second trend 1300B and the third trend 1300C may depict the calculated consumption of power by each of the plurality of chillers 106. In some embodiments, the graphical representation 1300 may comprise observations recorded for at least 24 hours of power consumption by each of the plurality of chillers 106.

As illustrated in FIG. 13B, the graphical representation 1302 may depict modeled energy consumption of each of the plurality of chillers 106. Further, the graphical representation 1302 may comprise a first trend 1302A, a second trend 1302B and a third trend 1302C. In some embodiments, the first trend 1302A, the second trend 1302B and the third trend 1302C may depict the evolution of modeled consumption of energy in time by each of the plurality of chillers 106. In some embodiments, the graphical representation 1302 may comprise observations recorded for at least 24 hours of modeled energy consumption by each of the plurality of chillers 106. Further, based at least on the depicted graphical representation 1302, the best performing chiller model may be determined.

As illustrated in FIG. 13C, the graphical representation 1304 may show comparison of power consumption of the plurality of chillers 106 in comparison to the best ML model. Further, the graphical representation 1304 may comprise a first trend 1304A, a second trend 1304B, and a third trend 1304C. In some embodiments, the first trend 1304A may relate to the best performing chiller model, the second trend 1304B and the third trend 1304C may depict the wasted energy by rest of the plurality of chillers 106. In some embodiments, the graphical representation 1304 may comprise observations recorded for at least 24 hours of wasted energy calculated with the best ML model power consumption as a baseline.

FIG. 14 illustrates a graphical representation 1400 of the chiller ML models by response on real inputs, in accordance with an example embodiment of the present disclosure.

The graphical representation 1400 may depict response of the chiller ML models on the real time inputs. Further, the graphical representation 1400 may comprise a first trend 1400A, a second trend 1400B and a third trend 1400C. Further, the first trend 1400A, the second trend 1400B and the third trend 1400C may relate to consumption of power by the plurality of chiller ML models.

FIGS. 15A-15B illustrate a graphical representation of comparisons of real chiller consumption to calculated consumptions as responses of models on real measured inputs, in accordance with an example embodiment of the present disclosure.

In some embodiments, the graphical representation 1500 may depict power consumption of the degraded chiller 106B. The graphical representation 1500 may comprise a first trend 1500A, a second trend 1500B, and a third trend 1500C. Further, the first trend 1500A may correspond to actual power consumption of the chiller 106B detected by the one or more sensors 108. Further, the second trend 1500B may correspond to power consumption of the chiller 106B predicted by the ML model. In some embodiments, consumption of the chiller 106B predicted by the ML model is an assessment of the power consumption of the chiller 106B if it were not degraded. Further, the third trend 1500C may correspond to power consumption calculated by the ML model of the best chiller 106A.

In some embodiments, the graphical representation 1502 may depict actual and modeled energy consumption trends of the degraded chiller 106B. Further, the graphical representation 1502 may comprise a first trend 1502A, a second trend 1502B and a third trend 1502C. Furthermore, the first trend 1502A, the second trend 1502B and the third trend 1502C may correspond to an actual daily profile of the degraded chiller 106B retrieved from monitoring, its modeled profile without degradation in time and estimated profile without degradation with best chiller 106A. Further, the graphic representation 1500 and the graphical representation 1502 may also be configured to depict a wastage of energy and power by the degraded chiller of the plurality of chillers 106.

FIGS. 16A-16F illustrate a graphical representation of comparison of real energy consumption of each chillers of the chiller plant 104 to calculate power consumptions as responses of models on real measured inputs, in accordance with an example embodiment of the present disclosure.

In some embodiments, the graphical representation 1600 may be configured to depict power consumption by the chiller 106A (e.g., CH0). The graphical representation 1600 may comprise a first trend 1600A, a second trend 1600B, and a third trend 1600C. Further, the first trend 1600A may correspond to actual power consumption of the chiller 106A. Further, the second trend 1600B may correspond to power consumption of the chiller 106A predicted by the ML model. Further, the third trend 1600C may correspond to power consumption calculated by the model of the best chiller 106A.

Further, the graphical representation 1602 may be configured to depict energy consumption trends by the chiller 106A (e.g., CH0). The graphical representation 1602 may comprise a first trend 1602A, a second trend 1602B, and a third trend 1602C. Further, the first trend 1602A may correspond to actual energy consumption of the chiller 106A. Further, the second trend 1602B may correspond to energy consumption predicted by the ML model of the chiller 106A. Further, the third trend 1602C may correspond to power consumption calculated by the model of the best chiller 106A.

In some embodiments, the graphical representation 1604 may be configured to depict power consumption by the chiller 106B (e.g., CH1). In some embodiments, the graphical representation 1604 may be configured to depict power consumption by the chiller 106B (e.g., CH1). The graphical representation 1604 may comprise a first trend 1604A, a second trend 1604B, and a third trend 1604C. Further, the first trend 1604A may correspond to actual power consumption of the chiller 106B. Further, the second trend 1604B may correspond to power consumption of the chiller 106B predicted by the ML model. Further, the third trend 1604C may correspond to power consumption calculated by the model of the best chiller 106A.

Further, the graphic representation 1606 may be configured to depict energy consumption trends by the chiller 106B (e.g., CH1). Further, the graphical representation 1606 may be configured to depict energy consumption by the chiller 106B (e.g., CH1). The graphical representation 1606 may comprise a first trend 1606A, a second trend 1606B, and a third trend 1606C. Further, the first trend 1606A may correspond to actual energy consumption of the chiller 106B. Further, the second trend 1606B may correspond to energy consumption of the chiller 106B predicted by the ML model. Further, the third trend 1606C may correspond to power consumption calculated by the model of the best chiller 106A.

In some embodiments, the graphical representation 1608 may be configured to depict power consumption by the chiller 106C (e.g., CH2). In some embodiments, the graphical representation 1608 may be configured to depict power consumption by the chiller 106C (e.g., CH2). The graphical representation 1608 may comprise a first trend 1608A, a second trend 1608B, and a third trend 1608C. Further, the first trend 1608A may correspond to actual power consumption of the chiller 106C. Further, the second trend 1608B may correspond to power consumption of the chiller 106C predicted by the ML model. Further, the third trend 1608C may correspond to power consumption calculated by the model of the best chiller 106A.

Further, the graphic representation 1610 may be configured to depict energy consumption by the chiller 106C (e.g., CH2). Further, the graphical representation 1610 may be configured to depict energy consumption by the chiller 106C (e.g., CH2). The graphical representation 1610 may comprise a first trend 1610A, a second trend 1610B, and a third trend 1610C. Further, the first trend 1610A may correspond to actual energy consumption of the chiller 106C. Further, the second trend 1610B may correspond to energy consumption of the chiller 106C predicted by the ML model. Further, the third trend 1610C may correspond to power consumption calculated by the model of the best chiller 106A.

FIGS. 17A-17D illustrate a graphical representation of daily assessment of the chiller plant 104, in accordance with an example embodiment of the present disclosure.

In some embodiments, the graphical representation 1700 may be configured to depict total power consumption by the chiller plant 104. The graphical representation 1700 may comprise a first trend 1700A, a second trend 1700B, and a third trend 1700C. Further, the first trend 1700A may correspond to actual power consumption of the chiller plant 104. Further, the second trend 1700B may correspond to power consumption of the non-degraded chiller plant predicted by its ML model. Further, the third trend 1700C may correspond to power consumption of the ideal chiller plant 104 using its ML model.

In some embodiments, the graphical representation 1702 may be configured to depict total energy consumption by the chiller plant 104. The graphical representation 1702 may comprise a first trend 1702A, a second trend 1702B, and a third trend 1702C. Further, the first trend 1702A may correspond to actual energy consumption of the chiller plant 104. Further, the second trend 1702B may correspond to energy consumption of the non-degraded chiller plant predicted by the ML model. Further, the third trend 1702C may correspond to energy consumption of the ideal chiller plant 104 using its ML model. In some embodiments, the graphical representation 1704 may be configured to depict estimated power wastage by the chiller plant 104.

In some embodiments, the scale 1706 depicts energy saving potential of the chiller plant 104 determined by ML models. Further, the scale 1706 depicts the estimated energy saving potential B (+6.3%) based on the degradation assessment and the further potential efficiency increase of the ideal chiller plant with chillers equal to the nondegraded best chiller.—A (+4.7%)). Total ideal efficiency increase potential is C (11%). Model uncertainty is depicted by blurred streaks D and E along the saving potential markers (illustrated by 1708).

FIGS. 18A-18B illustrate a graphical representation of yearly trend of daily chiller plant consumptions, in accordance with an example embodiment of the present disclosure.

In some embodiments, the graphical representation 1800 may depict power consumption of the chiller plant 104. Further, the graphical representation 1800 may comprise, a first trend 1800A and a second trend 1800B. In some embodiments, the first trend 1800A may relate to actual power consumed by the chiller plant 104. In some embodiments, the second trend 1800B may relate to power consumed by the ideal chiller plant 104 calculated by the best ML model. Further, the graphical representation 1800 may correspond to ideal saving potential of the chiller plant 104.

In some embodiments, the graphical representation 1802 may depict estimated energy savings potential by the chiller plant 104. Further, the graphical representation 1802 may comprise points 1802A that depict daily energy saving potential of the chiller plant 104, a trend 1802B that depicts moving average values of degradation based savings potential of the chiller plant 104 if model of the non-degraded chiller plant is used as a baseline, and a third trend 1802C that depicts estimated ideal energy saving potential of the chiller plant 104 if model of the ideal chiller plant 104 is used as a baseline.

FIG. 19 illustrates a graphical representation 1900 of yearly trend of chiller plant operation, in accordance with an example embodiment of the present disclosure.

In some embodiments, the graphical representation 1900 may provide an insight into runtime of each of the plurality of chillers 106 of the chiller plant 104 and to reveal a source of a potential chiller plant inefficiency. Further, the graphical representation 1900 may comprise a first trend 1900A, a second trend 1900B, and a third trend 1900C. Further, the first trend 1900A may correspond to cumulative run time of the first chiller 106A (i.e., CH0). Further, the second trend 1900B may correspond to cumulative run time of the second chiller 106B (i.e., CH1). Further, the third trend 1900C may correspond to cumulative run time of third chiller 106C (i.e., CH2).

The present disclosure provides continuous monitoring and analysis of chiller plant performance, enabling early detection of inefficiencies or abnormalities that could lead to increased operating costs. By leveraging machine learning algorithms, the system may predict potential energy inefficiencies and identify optimal operating conditions, leading to improved energy utilization and cost savings. Additionally, the system may provide insights into the individual contributions of each chiller within the plant, allowing for targeted maintenance and optimization strategies. Furthermore, by automating the evaluation process, the system may reduce the need for manual intervention, saving time and resources for building managers or maintenance personnel. Overall, the system may enhance the efficiency, reliability, and cost-effectiveness of chiller plant operation, ultimately leading to improved performance and reduced operational expenses.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving, via at least one processor, a first set of data associated with each of a plurality of chillers of a chiller plant, from one or more sensors, over a training interval;
generating, via the at least one processor, a machine learning (ML) model for each of the plurality of chillers of the chiller plant based at least on the received first set of data;
deploying, via the at least one processor, the generated at least one ML model to a model of each of the plurality of chillers of the chiller plant over a ranking interval;
receiving, via the at least one processor, a second set of data associated with each of the plurality of chillers of the chiller plant, from the one or more sensors, over the ranking interval;
averaging, via the at least one processor, the second set of data associated with each of the plurality of chillers of the chiller plant;
determining, via the at least one processor, a power consumption of each of the plurality of chillers of the chiller plant based at least on the averaged second set of data, using the at least one ML model; and
comparing, via the at least one processor, the power consumption of each model of a chiller of the plurality of chillers over the ranking interval to determine a best ML model.

2. The method of claim 1, wherein the one or more sensors comprises at least one of a temperature sensor, a humidity sensor, calorimeter, and a power meter.

3. The method of claim 1, wherein the first set of data and the second set of data comprises at least one of chilled water temperature, cooling water temperature, and cooling demand.

4. The method of claim 1, wherein the training interval and the ranking interval correspond to at least one of hours, days, months, quarters, or years in which the first set of data and the second set of data are received.

5. The method of claim 1, wherein the second set of data is averaged across each of the plurality of chillers to standardize and allow consistent input data for the at least one ML model for each of the plurality of chillers of the chiller plant.

6. The method of claim 1 further comprising deploying, via the at least one processor, the best ML model to the model of the each chiller of the chiller plant to form an ideal chiller plant ML model.

7. The method of claim 6 further comprising comparing, via the at least one processor, power consumption of each of the plurality of chillers of the chiller plant with the ideal chiller plant ML model to determine real time efficiency of each of the plurality of chillers of the chiller plant.

8. The method of claim 1, wherein the best ML model corresponds to a model of the chiller among the plurality of chillers having minimum electricity consumption.

9. A system comprising:
a memory; and
at least one processor communicatively coupled to the memory, wherein the at least one processor is configured to:
receive a first set of data associated with each of a plurality of chillers of a chiller plant, from one or more sensors, over a training interval;
generate a machine learning (ML) model for each of the plurality of chillers of the chiller plant based at least on the received first set of data;
deploy the generated at least one ML model to model of each of the plurality of chillers of the chiller plant over a ranking interval;
receive a second set of data associated with each of the plurality of chillers of the chiller plant, from the one or more sensors, over the ranking interval;
average the second set of data associated with each of the plurality of chillers of the chiller plant;
determine a power consumption of each of the plurality of chillers of the chiller plant based at least on the averaged second set of data, using the at least one ML model; and
compare the power consumption of each model of a chiller of the plurality of chillers over the ranking interval to determine a best ML model.

10. The system of claim 9, wherein the one or more sensors comprises at least one of a temperature sensor, a humidity sensor, and a power meter.

11. The system of claim 9, wherein the first set of data and the second set of data comprises at least one of chilled water temperature, cooling water temperature, and cooling demand.

12. The system of claim 9, wherein the training interval and the ranking interval correspond to at least one of hours, days, months, quarters, or years in which the first set of data and the second set of data are received.

13. The system of claim 9, wherein the second set of data is averaged to standardize and allow consistent input data for the at least one ML model for each of the plurality of chillers of the chiller plant.

14. The system of claim 9, wherein the at least one processor is further configured to deploy the best ML model to the model of the each chiller of the chiller plant to form an ideal chiller plant ML model.

15. The system of claim 14, wherein the at least one processor is further configured to compare power consumption of each model of the chiller of the plurality of chillers of the chiller plant with the ideal chiller plant ML model to determine real time efficiency of each of the plurality of chillers of the chiller plant.

16. The system of claim 9, wherein the best ML model corresponds to a model of the chiller among the plurality of chiller models having minimum electricity consumption.

17. A non-transitory machine-readable information storage medium comprising one or more instructions which when executed by at least one processor to perform operations comprising:
receiving a first set of data associated with each of a plurality of chillers of a chiller plant, from one or more sensors, over a training interval;
generating a machine learning (ML) model for each of the plurality of chillers of the chiller plant based at least on the received first set of data;
deploying the generated at least one ML model to a model of each chiller of the plurality of chillers of the chiller plant over a ranking interval;
receiving a second set of data associated with each of the plurality of chillers of the chiller plant, from the one or more sensors, over the ranking interval;
averaging the second set of data associated with each of the plurality of chillers of the chiller plant;
determining a power consumption of each of the plurality of chillers of the chiller plant based at least on the averaged second set of data, using the at least one ML model; and
comparing the power consumption of each of the plurality of chillers over the ranking interval to determine a best ML model.

18. The non-transitory machine-readable information storage medium of claim 17, wherein the one or more sensors comprises at least one of a temperature sensor, a humidity sensor, calorimeter, and a power meter, and wherein the first set of data and the second set of data comprises chiller water temperature, cooling water temperature, and cooling demand, and wherein the second set of data is averaged to standardize and allow consistent input data for the at least one ML model for each of the plurality of chillers of the chiller plant.

19. The non-transitory machine-readable information storage medium of claim 17, wherein the at least one processor is further configured to:
deploy the best ML model to the model of the each chiller of the chiller plant to form an ideal chiller plant ML model; and
compare power consumption of each model of chiller of each of the plurality of chillers of the chiller plant with a non-degraded chiller plant ML model and the ideal chiller plant ML model to determine estimated efficiency of each of the plurality of chillers of the chiller plant.

20. The non-transitory machine-readable information storage medium of claim 17, wherein the best ML model corresponds to a model of the chiller among the plurality of chillers having minimum electricity consumption.
